(19) United States
(12) Patent Application Publication
(10) Pub. No.: US 2010/0171592 A1
(43) Pub. Date: Jul. 8, 2010

(54) DETERMINING APPARATUS AND COMPUTER PROGRAM AND DETERMINING METHOD

(75) Inventor: Toshihisa Kamemaru, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Tokyo (JP)

(21) Appl. No.: 12/492,520

(22) Filed: Jun. 26, 2009

(30) Foreign Application Priority Data
Jan. 8, 2009 (JP) 2009-002121

(51) Int. Cl. H04B 7/00; H04B 17/00

(52) U.S. Cl. 340/10.1; 455/226.2

(57) ABSTRACT

A determining apparatus ensures an assurance value of reliability in the determination result for determining the correct tag. A signal receiving unit 121 receives a signal transmitted by the tag (the communication apparatus), a plurality of times. An identification acquiring unit 122 acquires identification data of the tag based on the received signal. The reception counting unit 123 counts a number of reception times the signal is received for each tag. The apparatus determining unit 132 determines that the tag having the more number of reception times as the correct tag (the communication partner) when the difference in the number of reception times is greater than or equal to the times difference threshold.

### BACKGROUND OF THE INVENTION

1. Field of the Invention

The present invention relates to a determining apparatus for determining a correct communication partner.

2. Description of the Related Art

In an RFID (Radio Frequency Identification) system, a reader apparatus utilizes radio communication to read an ID (the identification data) or other data possessed by a tag. The radio communication with the tag is performed via an antenna which is connected to the reader apparatus through a cable, and the like. A communication range with the tag is decided by the antenna's directivity or an output electricity of the radio wave of the reader apparatus. When a plurality of tags is present in a communication possible range within reach of the radio wave, all of these tags responds, and returns ID or data. The reaching ranges of the radio waves differ depending on their frequencies, characteristics of radio wave propagation, the output electricity (regulated by domestic Radio Wave Rules) of the reader apparatus, and so forth. For example, the communication between the tag and the reader apparatus is possible up to a distance of about 5 meters at maximum when the RFID system utilizes a band ranging from 952 to 954 MHz.

### RELATED ARTS

### [Patent Document 1] Japanese Published Patent Application No. 2008-129652

### [Patent Document 2] Japanese Published Patent Application No. 2007-122604

### [Patent Document 3] Japanese Published Patent Application No. 2007-217069

### SUMMARY OF THE INVENTION

When the communication range is wide such as this, the radio wave generates fading, due to influences of structural objects such as floor and wall, or object placed nearby, or even human, so that an ID of the tag that should not be read might be wrongly read.

A conventional method being proposed for determining the correct communication partner cannot be employed to a system requiring a high reliability because a probability of making the wrong determination is unknown.

The present invention, for example, attempts to solve the above-mentioned problem. The present invention is directed to secure a high reliability by ensuring that a probability that the determination result for determining the correct communication partner is the wrong determination, is less than or equal to a prescribed probability.

According to an aspect of the determining apparatus of the present invention, a determining apparatus for receiving each signal transmitted by one or more communication apparatuses, and determines a communication apparatus serving as a communication partner out of the communication apparatuses transmitted the signal received, the determining apparatus comprising: a receiving apparatus for receiving a signal, a processing apparatus for processing data, a signal receiving unit, an identification acquiring unit, a reception counting unit, and an apparatus determining unit; and wherein the signal receiving unit, by using the receiving apparatus, receives each signal transmitted by one or more communication apparatuses, a plurality of times; wherein the identification acquiring unit, by using the processing apparatus, based on each signal received by the signal receiving unit, acquires identification data for identifying the communication apparatus that has transmitted the signal received by the signal receiving unit; wherein the reception counting unit, by using the processing apparatus, based on the identification data acquired by the identification acquiring unit, counts each number of reception times the signal receiving unit has received the signal, for each communication apparatus identified by the identification data; wherein the apparatus determining unit, by using the processing apparatus, based on the number of reception times counted by the reception counting unit, calculates a difference in the number of reception times between one communication apparatus and another communication apparatus, compares the difference in the number of reception times calculated with a prescribed times difference threshold, and determines a communication apparatus having a more number of reception times as the communication partner, when the difference in the number of reception times is greater than or equal to the times difference threshold.

According to the determining apparatus of the present invention, when the difference in the number of reception times is greater than or equal to the times difference threshold, the apparatus determining unit determines the communication apparatus having the more number of reception times as the communication partner, thereby obtaining a highly reliable determination result at a simple determining method, as well as ensuring that a probability of making the wrong determination is less than or equal to a prescribed probability.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute apart of the specification, illustrate exemplary embodiments, features, and aspects of the invention and, together with the description, serve to explain the principles of the invention.

FIG. 1 illustrates a system configuration chart showing an example of an entire configuration of the RFID system 800, in accordance with a first embodiment.

FIG. 2 illustrates a block configuration chart showing an example of a functional block configuration of the RFID reader apparatus 100, in accordance with the first embodiment.

FIG. 3 illustrates a flowchart showing an example of a flow of a determining process S610, in accordance with the first embodiment.

FIG. 4 illustrates a flowchart showing an example of a flow of a times difference threshold calculating process S630, in accordance with the first embodiment.

FIG. 5 illustrates a flowchart showing an example of a reception probability calculating process S650, in accordance with the first embodiment.

FIG. 6 illustrates a flowchart showing an example of a flow of the times difference threshold calculating process S630, in accordance with a second embodiment.

FIG. 7 illustrates a flowchart showing an example of a flow of an apparatus determining step S620, in accordance with the second embodiment.

FIG. 8 illustrates a drawing showing an example of a times difference threshold calculated by the times difference threshold calculating unit 163, in accordance with the second embodiment.

FIG. 9 illustrates a drawing showing an example of a times difference threshold calculated by a times difference threshold calculating unit 163, in accordance with a third embodiment.

FIG. 10 illustrates a drawing showing an example of a times difference threshold calculated by the times difference threshold calculating unit 163, in accordance with the third embodiment.

FIG. 11 illustrates a block configuration chart showing an example of a functional block configuration of the RFID reader apparatus 100, in accordance with a fifth embodiment.

FIG. 12 illustrates a flowchart showing an example of a flow of the determining process S610, in accordance with the fifth embodiment.

FIG. 13 illustrates a flowchart showing an example of a flow of an electrical power testing step S626, in accordance with the fifth embodiment.

### DETAILED DESCRIPTION OF THE EMBODIMENTS

Various exemplary embodiments, features, and aspects of the invention will be described in detail below with reference to the drawings.

### First Embodiment

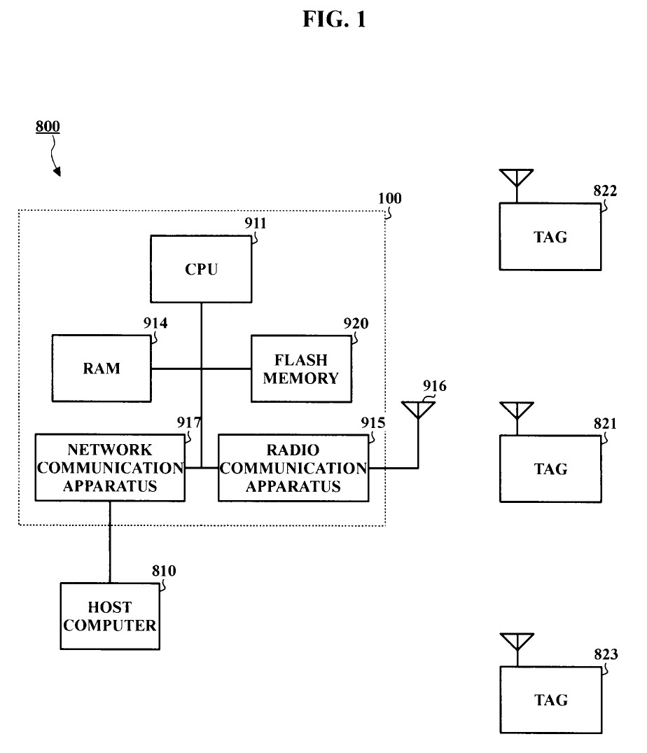

The first embodiment is described with reference to the drawings of FIGS. 1 to 5.

FIG. 1 illustrates a system configuration chart showing an example of the entire configuration of the RFID system 800, in accordance with the present embodiment.

The RFID system 800 has an RFID reader apparatus 100, and a host computer 810.

The RFID reader apparatus 100 communicates to tags 821 to 823, based on an instruction from the host computer 810.

The RFID reader apparatus 100 has a CPU 911, a RAM 914, a radio communication apparatus 915, an antenna 916, an network communication apparatus 917, and a flash memory 920.

The flash memory 920 (the storage apparatus) is one example of non-volatile storage apparatuses, and stores programs executed by the CPU 911, data processed by the CPU 911, and the like.

The RAM 914 (the storage apparatus) is one example of volatile storage apparatuses, and temporarily stores data and the like processed by the CPU 911.

The CPU 911 (the processing apparatus) processes data by executing the programs stored on the flash memory 920 and the like, and controls an entire operation of the RFID reader apparatus 100.

The radio communication apparatus 915 (a transmitting apparatus and a receiving apparatus) radiates a carrier wave for supplying operation power to the tags 821 to 823, via the antenna 916. The radio communication apparatus 915 converts data sent from the CPU 911 into a wireless signal by modulating the carrier wave for radiating, and transmits the wireless signal to the tags 821 to 823. Moreover, the radio communication apparatus 915 receives signals from the tags 821 to 823 via the antenna 916, converts the signals into data, and sends the data to the CPU 911.

A network communication apparatus 917 transmits the data sent from the CPU 911 to the host computer 810, receives data from the host computer 810, and transmits the data to the CPU 911.

A user of the RFID system 800 places a tag 821, which he intends to make communicate with the RFID reader apparatus 100, within a reading range of the RFID reader apparatus 100. The tag 821 is activated by obtaining the operation power from the carrier wave radiated by the RFID reader apparatus 100, and receives data transmitted by the RFID reader apparatus 100. The tag 821 interprets the received data as commands, and operates according to the interpreted commands. For example, the tag 821 reads its own identification data stored on itself, and transmits the identification data to the RFID reader apparatus 100.

As the commands transmitted to the tag 821 by the RFID reader apparatus 100, there are a command that specifies a partner by using the identification data, and a command that does not particularly specify the partner. Ina series of communication, the RFID reader apparatus 100, for example, at first, transmits the command that does not specify the partner to make the tag 821 transmit the identification data of itself, and acquires an identification data of the communication partner. Next time and later, the RFID reader apparatus transmits the command that specifies the partner by using the acquired identification data.

When the tag 821 receives the command that specifies the partner by using the identification data it compares the identification data of the tag 821 stored on itself with the identification data specified by the command, and operates according to the command only when they match.

When the tag 822 or 823, which the user of the RFID system 800 doesn't intend to make communicate with the RFID reader apparatus 100, is present near the reading range of the RFID reader apparatus 100, it might be activated by receiving the carrier wave radiated by the RFID reader apparatus 100 in some cases. When the command transmitted by the RFID reader apparatus 100 is the command that specifies the partner by using the identification data, even if the tag 822 or 823 receives this command, since the identification data of the tag 822 or 823 stored on itself does not match the identification data specified by the command, therefore, the tag 822 or 823 ignores the received command.

In contrast to this, when the command transmitted by the RFID reader apparatus 100 is the command that does not specify the partner, the tag 822 or 823 operates according to the received command. For example, when the received command is a command requesting transmission of the identification data, the tag 822 or 823 transmits its own identification data to the RFID reader apparatus 100.

For this reason, the RFID reader apparatus 100 determines whether the received identification data belongs to the tag 821 which is intended by the user to communicate with the RFID reader apparatus 100, or belongs to the tag 822 or 823 which is unintended for communication. Hereinbelow, the tag 821 which is intended for communication by the user is called “the correct tag” and the tag 822 or 823 which is unintended for communication by the user is called “the wrong tag”.

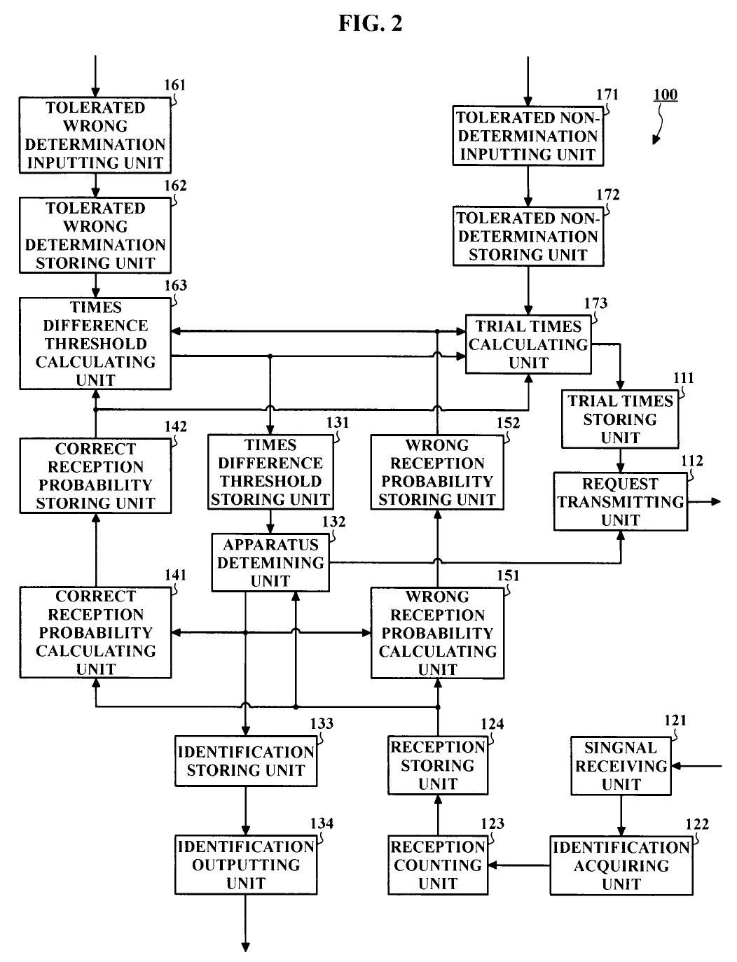

FIG. 2 illustrates a block configuration chart showing an example of the functional block configuration of the RFID reader apparatus 100, in accordance with the present embodiment.

The functional block shown herein, for example, is implemented by executing a program stored on the flash memory 920 by the CPU 911. Besides, some or all of these functional blocks may be implemented by using an IC, a digital circuit, an analog circuit, and so forth.

The RFID reader apparatus 100 (the determining apparatus) comprises a trial times storing unit 111, a request transmitting unit 112, a signal receiving unit 121, an identification acquiring unit 122, a reception counting unit 123, a reception storing unit 124, a times difference threshold storing unit 131, an apparatus determining unit 132, an identification storing unit 133, an identification outputting unit 134, a correct reception probability calculating unit 141, a correct reception probability storing unit 142, a wrong reception probability calculating unit 151, a wrong reception probability storing unit 152, a tolerated wrong determination inputting unit 161, a tolerated wrong determination storing unit 162, a times difference threshold calculating unit 163, a tolerated non-determination inputting unit 171, a tolerated non-determination storing unit 172, and a trial times calculating unit 173.

First of all, a configuration of determining the correct tag will be described.

The trial times storing unit 111, by using the flash memory 920, stores data indicating a maximum number of trial times in advance.

The request transmitting unit 112, by using the radio communication apparatus 915, transmits the command requesting transmission of the identification data without specifying the communication partner (hereinafter referred to as “identification requesting command”). With just one transmission, it is probable that a correct tag may not respond or a wrong tag may respond, so that the request transmitting unit 112 transmits the identification requesting command, a plurality of times.

For instance, the request transmitting unit 112, by using the RAM 914, stores a data indicating 0 as a number of trial times. The request transmitting unit 112, by using the CPU 911, inputs the maximum number of trial times stored by the trial times storing unit 111. The request transmitting unit 112, by using the radio communication apparatus 915, transmits the identification requesting command. The request transmitting unit 112, by using the CPU 911, adds 1 to the number of trial times indicated by the stored data, and updates the stored data. When the number of trial times indicated by the updated data is less than the maximum number of trial times indicated by the inputted data, the request transmitting unit 112, by using the CPU 911, inputs a data indicating the determination result outputted by the apparatus determining unit 132 which will be described later. The request transmitting unit 112, by using the CPU 911, based on the determination result indicated by the inputted data, will know whether or not the apparatus determining unit 132 has determined the correct tag. When the apparatus determining unit 132 has not determined the correct tag, the request transmitting unit 112, by using the radio communication apparatus 915, transmits the identification requesting command once more. The request transmitting unit 112 repeats this until the apparatus determining unit 132 determines the correct tag or until the number of trial times attains the maximum number of trial times.

The signal receiving unit 121, by using the radio communication apparatus 915, receives signals transmitted by the tags 821 to 823 as responses to the identification requesting command transmitted by the request transmitting unit 112. The signal receiving unit 121, by using the CPU 911, outputs the data indicated by the received signals.

The identification acquiring unit 122, by using the CPU 911, acquires the identification data of a tag that has transmitted its signal, from the signals received by the signal receiving unit 121.

For instance, the identification acquiring unit 122, by using the CPU 911, inputs the data outputted by the signal receiving unit 121. The identification acquiring unit 122, by using the CPU 911, based on the inputted data, acquires the identification data of the tag that has transmitted the signal received by the signal receiving unit 121. When a plurality of tags respond to one identification requesting command, the identification acquiring unit 122 acquires the respective identification data of the plurality of tags responded. The identification acquiring unit 122, by using the CPU 911, outputs the acquired identification data.

The reception counting unit 123, by using the CPU 911, counts how many times each tag has responded to the identification requesting command transmitted a plurality of times by the request transmitting unit 112.

The reception storing unit 124, by using the RAM 914, stores the identification data of a tag that has responded once or more and the data indicating a number of times that the tag has responded to the identification requesting command transmitted a plurality of times by the request transmitting unit 112.

For instance, the reception storing unit 124, before the request transmitting unit 112 transmits a series of the identification requesting commands, by using the CPU 911, initializes and deletes the stored data. The reception counting unit 123, by using the CPU 911, inputs the identification data outputted by the identification acquiring unit 122. The reception counting unit 123, by using the CPU 911, determines whether or not the reception storing unit 124 is storing an identification data that matches to the inputted identification data.

When the reception storing unit 124 is storing the matching identification data, the reception counting unit 123, by using the CPU 911, inputs data regarding the tag stored by the reception storing unit 124, adds 1 to the number of response times indicated by the inputted data, and updates the data stored by the reception storing unit 124. The reception storing unit 124, by using the RAM 914, stores the updated data.

When the reception storing unit 124 is not storing the matching identification data, the reception counting unit 123, by using the CPU 911, outputs the inputted identification data and the data indicating 1 as the number of response times of the tag. The reception storing unit 124, by using the CPU 911, inputs the data outputted by the reception counting unit 123, and by using the RAM 914, newly appends and stores the inputted identification data and the data indicating the number of response times.

When there are a plurality of identification data inputted by the reception counting unit 123, these processes are repeated on all the identification data.

The times difference threshold storing unit 131, by using the flash memory 920, stores data indicating a times difference threshold in advance.

The apparatus determining unit 132, by using the CPU 911, determines which tag is the correct tag, based on the number of response times of each tag and the times difference threshold.

For instance, the apparatus determining unit 132, by using the CPU 911, inputs the data stored by the reception storing unit 124 and the data stored by the times difference threshold storing unit 131. The apparatus determining unit 132, determines which tag is the correct tag, based on the number of response times of each tag and the times difference threshold, indicated by the inputted data.

When the determination is successful, the apparatus determining unit 132, by using the CPU 911, outputs identification data of the tag which is determined as correct.

When unable to determine which tag is the correct tag, the apparatus determining unit 132, by using the CPU 911, outputs data indicating that the correct tag could not have been determined.

A user follows a handling manual of the RFID reader apparatus 100 and places the correct tag within the reading range of the RFID reader apparatus 100. For this reason, a probability that the correct tag responds to the identification requesting command (hereinafter referred to as “correct reception probability”) is high.

In contrast to this, the user tries to keep the wrong tag distant from the reading range of the RFID reader apparatus 100. Although there may be a case in which the wrong tag responds due to influences caused by the reading range of the RFID reader apparatus 100 which is actually wider than what the user has primarily expected or caused by fading or reflection of the radio waves affected by surrounding objects, however, a probability that the wrong tag responds to the identification requesting command (hereinafter referred to as “wrong reception probability”) is lower than that of the correct reception probability.

Thus, the number of response times of the correct tag tends to be probabilistically greater than the number of response times of the wrong tag.

The apparatus determining unit 132, by using the CPU 911, inputs the data indicating the number of response times of each tag stored by the reception storing unit 124 and the data indicating the times difference threshold stored by the times difference threshold storing unit 131. The apparatus determining unit 132, by using the CPU 911, based on the inputted data, calculates a difference between the number of response times of one tag and the number of response times of another tag. The apparatus determining unit 132, by using the CPU 911, compares a calculated difference with the times difference threshold indicated by the inputted data. When the calculated difference is equal to or greater than the times difference threshold, the apparatus determining unit 132, by using the CPU 911, determines a tag having the more number of response times as the correct tag.

The identification storing unit 133, by using the CPU 911, inputs a data outputted by the apparatus determining unit 132. When the inputted data is the identification data, the identification storing unit 133, by using the flash memory 920, stores the inputted identification data as the identification data of the communication partner.

The identification outputting unit 134, by using the CPU 911, inputs the identification data stored by the identification storing unit 133. The identification outputting unit 134, by using the network communication apparatus 917, transmits the inputted identification data to the host computer 810.

The configuration of determining the correct tag has been described so far.

Next, a configuration of calculating the times difference threshold will be described.

The correct reception probability calculating unit 141, by using the CPU 911, calculates the correct reception probability.

The correct reception probability storing unit 142, by using the flash memory 920, stores the correct reception probability.

For instance, the correct reception probability storing unit 142, by using the CPU 911, initializes the data stored by the flash memory 920 beforehand, and, stores, by using the flash memory 920, a data indicating a prescribed initial value (for example, 0.8) which is previously defined.

The correct reception probability calculating unit 141, by using the CPU 911, inputs the data outputted by the apparatus determining unit 132. The correct reception probability calculating unit 141, when the inputted data is serving as the identification data, by using the CPU 911, searches the data stored by the reception storing unit 124, and acquires the data indicating the number of response times of the tag determined by the apparatus determining unit 132 as the correct tag. The correct reception probability calculating unit 141, by using the CPU 911, based on the number of response times indicated by the acquired data, updates the data stored by the correct reception probability storing unit 142. The correct reception probability storing unit 142, by using the flash memory 920, stores the updated data.

The correct reception probability, for example, is updated as described below.

The correct reception probability calculating unit 141, by using the CPU 911, divides the number of response times of the tag indicated by the acquired data by a number of times the request transmitting unit 112 transmitted the identification requesting command, to calculate a response probability of the tag in a previous trial. Moreover, when there are a plurality of tags determined as the correct tags by the apparatus determining unit 132, the correct reception probability calculating unit 141, by using the CPU 911, sums up the numbers of response times of the plurality of tags, and divides the sum of the numbers of response times by a number obtained by multiplying a number of tags determined as the correct tags by the apparatus determining unit 132 and a number of transmission times of the identification requesting command, to be taken as the response probability of the tags in the previous trial. The correct reception probability calculating unit 141, by using the CPU 911, inputs the data indicating the correct reception probability stored by the correct reception probability storing unit 142. The correct reception probability calculating unit 141, by using the CPU 911, multiplies the correct reception probability indicated by the inputted data to a prescribed time constant α which is previously defined, and multiplies the new response probability calculated to (1−α), and totalizes these two. Note that the time constant α is a real number greater than 0 and less than 1, for example, 0.99. The correct reception probability calculating unit 141, by using the CPU 911, takes the calculated total as the updated correct reception probability. The correct reception probability storing unit 142, by using the flash memory 920, stores the updated correct reception probability calculated by the correct reception probability calculating unit 141.

Meanwhile, the configuration related to the correct reception probability may be configured: to update the correct reception probability every time the apparatus determining unit 132 determines the correct tag. Alternatively, it may be configured: to update the correct reception probability only during a calibration period which is specified by, for example, the host computer 810, and not to update the correct reception probability during period other than the calibration period.

Alternatively, it may be configured that: a correct reception probability inputting unit is installed in place of the correct reception probability calculating unit 141; the correct reception probability inputting unit, for example, by using the network communication apparatus 917, receives the data indicating the correct reception probability specified by the host computer 810; and the correct reception probability storing unit 142 stores the data.

The wrong reception probability calculating unit 151, by using the CPU 911, calculates the wrong reception probability.

The wrong reception probability storing unit 152, by using the flash memory 920, stores the wrong reception probability.

For example, the wrong reception probability storing unit 152, by using the CPU 911, initializes the data stored by the flash memory 920 beforehand, and, stores, by using the flash memory 920, a data indicating a prescribed initial value (for example, 0.2) which is previously defined.

The wrong reception probability calculating unit 151, by using the CPU 911, inputs the data outputted by the apparatus determining unit 132. The wrong reception probability calculating unit 151, when the inputted data is serving as the identification data, by using the CPU 911, searches the data stored by the reception storing unit 124, and acquires the data indicating the number of response times of the tag other than the tag that the apparatus determining unit 132 determines as the correct tag. The wrong reception probability calculating unit 151, by using the CPU 911, based on the number of response times indicated by the acquired data, updates the data stored by the wrong reception probability storing unit 152. The wrong reception probability storing unit 152, by using the flash memory 920, stores the updated data.

Meanwhile, the configuration related to the wrong reception probability may be configured to update the wrong reception probability by using the same method as that of the correct reception probability. Alternatively, it may be configured to update the wrong reception probability by using a different method from the correct reception probability.

Alternatively, it may be configured that: a wrong reception probability inputting unit is installed in place of the wrong reception probability calculating unit 151; the wrong reception probability inputting unit, for example, by using the network communication apparatus 917, receives a data indicating the wrong reception probability specified by the host computer 810; and the wrong reception probability storing unit 152 stores the data.

The tolerated wrong determination inputting unit 161, by using the CPU 911, inputs a tolerated wrong determination probability.

The tolerated wrong determination storing unit 162, by using the flash memory 920, stores data indicating the tolerated wrong determination probability.

The tolerated wrong determination probability means a maximum value tolerated as a probability that the apparatus determining unit 132 wrongly determines the wrong tag as the correct tag, for example, one millionth. Since the determination performed by the apparatus determining unit 132 is probabilistic, therefore, the probability of making the wrong determination cannot completely become 0. A value serving as a level of no practical problem is specified as the tolerated wrong determination probability.

For instance, the tolerated wrong determination inputting unit 161, by using the network communication apparatus 917, inputs the data indicating the tolerated wrong determination probability specified by the host computer 810. The tolerated wrong determination inputting unit 161, by using the CPU 911, outputs the inputted data. The tolerated wrong determination storing unit 162, by using the CPU 911, inputs the data outputted by the tolerated wrong determination inputting unit 161. The tolerated wrong determination storing unit 162, by using the flash memory 920, stores the inputted data.

Meanwhile, the configuration related to the tolerated wrong determination probability may be configured that: the tolerated wrong determination inputting unit is not installed; and the tolerated wrong determination storing unit stores a prescribed value which is defined in advance as the tolerated wrong determination probability.

The times difference threshold calculating unit 163, by using the CPU 911, calculates the times difference threshold.

The times difference threshold storing unit 131, by using the flash memory 920, stores data indicating the times difference threshold calculated by the times difference threshold calculating unit 163.

For instance, the times difference threshold calculating unit 163, by using the CPU 911, inputs the data indicating the correct reception probability stored by the correct reception probability storing unit 142, the data indicating the wrong reception probability stored by the wrong reception probability storing unit 152, and the data indicating the tolerated wrong determination probability stored by the tolerated wrong determination storing unit 162. The times difference threshold calculating unit 163, by using the CPU 911, based on the inputted data, calculates the times difference threshold in which the probability of making the wrong determination is less than or equal to the tolerated wrong determination probability, by using the correct reception probability and the wrong reception probability. The times difference threshold calculating unit 163, by using the CPU 911, outputs the data indicating the calculated times difference threshold. The times difference threshold storing unit 131, by using the CPU 911, inputs the data outputted by the times difference threshold calculating unit 163. The times difference threshold storing unit 131, by using the flash memory 920, stores the inputted data.

Meanwhile, the configuration related to the times difference threshold may be configured that: a times difference threshold inputting unit is installed in place of the configuration of calculating the times difference threshold described previously; and the times difference threshold inputting unit receives, for example, by using the network communication apparatus 917, a data indicating the times difference threshold specified by the host computer 810.

The configuration of calculating the times difference threshold has been described so far.

Next, a configuration of calculating the maximum number of trial times will be described.

The tolerated non-determination inputting unit 171, by using the CPU 911, inputs a tolerated non-determination probability.

The tolerated non-determination storing unit 172, by using the flash memory 920, stores data indicating the tolerated non-determination probability.

The tolerated non-determination probability means a maximum value tolerated as a probability that the apparatus determining unit 132 still cannot determine the correct tag when the request transmitting unit 112 has transmitted the identification requesting command the maximum number of trial times, for example, one hundredth. The smaller the tolerated wrong determination probability, the greater the times difference threshold by that amount, such that the probability that the apparatus determining unit 132 cannot determine the correct tag gets high if the maximum number of trial times is not increased. On the other hand, if the maximum number of trial times is unlimitedly increased, the communication time taken in determining the correct tag is increased, and the system may lose practical usefulness. Hence, a value serving as a level of the practical problem is specified as the tolerated non-determination probability.

For instance, the tolerated non-determination inputting unit 171, by using the network communication apparatus 917, inputs the data indicating the tolerated non-determination probability specified by the host computer 810. The tolerated non-determination inputting unit 171, by using the CPU 911, outputs the inputted data. The tolerated non-determination storing unit 172, by using the CPU 911, inputs the data outputted by the tolerated non-determination inputting unit 171. The tolerated non-determination storing unit 172, by using the flash memory 920, stores the inputted data.

Meanwhile, the configuration related to the tolerated non-determination probability may be configured that: the tolerated non-determination inputting unit 171 is not installed; the tolerated non-determination storing unit 172 stores a prescribed value which is defined in advance as the tolerated non-determination probability.

The trial times calculating unit 173, by using the CPU 911, calculates the maximum number of trial times.

The trial times storing unit 111, by using the flash memory 920, stores the data indicating the maximum number of trial times calculated by the trial times calculating unit 173.

For instance, the trial times calculating unit 173, by using the CPU 911, inputs the data indicating the correct reception probability stored by the correct reception probability storing unit 142, the data indicating the wrong reception probability stored by the wrong reception probability storing unit 152, the data indicating the times difference threshold outputted by the times difference threshold calculating unit 163, and the data indicating the tolerated non-determination probability stored by the tolerated non-determination storing unit 172. The trial times calculating unit 173, by using the CPU 911, based on the inputted data, calculates the maximum number of trial times in order that the probability that the apparatus determining unit 132 cannot determine the correct tag is less than or equal to the tolerated non-determination probability. The trial times calculating unit 173, by using the CPU 911, outputs the data indicating the maximum number of trial times calculated. The trial times storing unit 111, by using the CPU 911, inputs the data outputted by the trial times calculating unit 173. The trial times storing unit 111, by using the flash memory 920, stores the inputted data.

Meanwhile, the configuration related to the maximum number of trial times may be configured that: a trial times inputting unit is installed in place of the configuration of calculating the maximum number of trial times described previously; and the trial times inputting unit receives, for example, by using the network communication apparatus 917, a data indicating the maximum number of trial times specified by the host computer 810; and the trial times storing unit 111 stores the data. Alternatively, it may be configured that: in addition to the configuration described in the previous texts, a non-determination probability calculating unit and a non-determination probability outputting unit are installed; the non-determination probability calculating unit, by using the CPU 911, based on the correct reception probability, the wrong reception probability, the times difference threshold, and the maximum number of trial times, calculates the probability that the apparatus determining unit 132 cannot determine the correct tag, as a non-determination probability; the non-determination probability outputting unit transmits, for example, by using the network communication apparatus 917, the non-determination probability to the host computer 810.

Alternatively, it may be configured that: the configuration of calculating the maximum number of trial times and the trial times inputting unit are not installed; and the trial times storing unit 111 stores a prescribed integer defined in advance as the maximum number of trial times. In this case, the trial times storing unit 111 stores, for example, an integer not less than 10 and not exceeding 30, preferably about 20, as the maximum number of trial times.

An operation is described next.

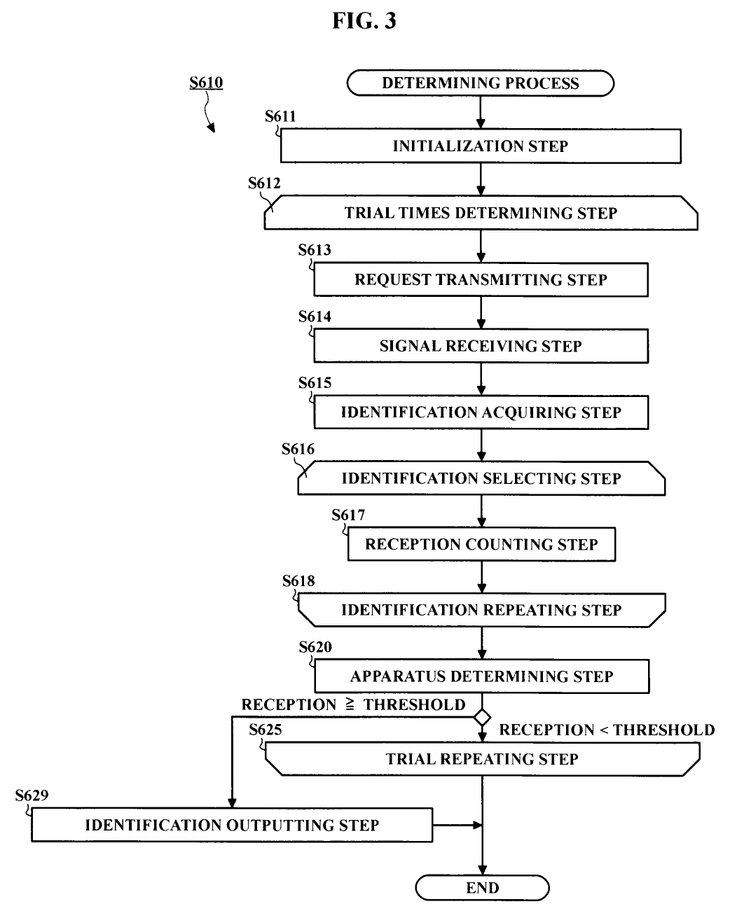

FIG. 3 illustrates a flowchart showing an example of a flow of the determining process S610, in accordance with the present embodiment.

In the determining process S610, the RFID reader apparatus 100 determines the correct tag.

The determining process S610 includes an initialization step S611, a trial times determining step S612, a request transmitting step S613, a signal receiving step S614, an identification acquiring step S615, an identification selecting step S616, a reception counting step S617, an identification repeating step S618, an apparatus determining step S620, a trial repeating step S625, and an identification outputting step S629.

Meanwhile, in the present example, a user places one by one the tags within the reading range of the RFID reader apparatus 100 for communicating with the RFID reader apparatus 100. That is, the RFID reader apparatus 100 knows in advance that the number of the correct tag is 1.

In the initialization step S611, the request transmitting unit 112, by using the RAM 914, stores “0” as a number of trial times. The reception storing unit 124, by using the CPU 911, initializes the number of reception times of all the tags to “0”, and stores them by using the RAM 914.

In the trial times determining step S612, the request transmitting unit 112, by using the CPU 911, compares the number of trial times stored with the maximum number of trial times stored by the trial times storing unit 111.

When the number of trial times is greater than or equal to the maximum number of trial times, the request transmitting unit 112, by using the CPU 911, ends the determining process S610 without determining the correct tag.

When the number of trial times is less than the maximum number of trial times, the request transmitting unit 112, by using the CPU 911, proceeds to the request transmitting step S613.

In the request transmitting step S613, the request transmitting unit 112, by using the radio communication apparatus 915, transmits the identification requesting command.

In the signal receiving step S614, the signal receiving unit 121, by using the radio communication apparatus 915, receives the signals transmitted by the tags 821 to 823 as responses to the identification requesting command transmitted by the request transmitting unit 112 in the request transmitting step S613.

In the identification acquiring step S615, the identification acquiring unit 122, by using the CPU 911, acquires the identification data of the tags 821 to 823, based on the signals received by the signal receiving unit 121 in the signal receiving step S614.

In the identification selecting step S616, the reception counting unit 123, by using the CPU 911, selects an identification data, one by one successively, out of the identification data acquired by the identification acquiring unit 122 in the identification acquiring step S615.

In the reception counting step S617, the reception counting unit 123, by using the CPU 911, adds “1” to the number of reception times of the tag identified by the identification data selected in the identification selecting step S616, which is stored by the reception storing unit 124.

In the identification repeating step S618, the reception counting unit 123, by using the CPU 911, determines whether or not a process of the reception counting step S617 for all the identification data acquired by the identification acquiring unit 122 in the identification acquiring step S615 is finished.

When there is an unprocessed identification data, the reception counting unit 123, by using the CPU 911, returns to the identification selecting step S616, and selects the next identification data.

When there is no unprocessed identification data, the reception counting unit 123, by using the CPU 911, proceeds to the apparatus determining step S620.

In the apparatus determining step S620, the apparatus determining unit 132, by using the CPU 911, calculates a difference between the number of reception times, which is the largest one of the numbers of reception times stored by the reception storing unit 124, and that, which is the second-largest one. The apparatus determining unit 132, by using the CPU 911, compares the calculated difference with the times difference threshold stored by the times difference threshold storing unit 131.

When the calculated difference is greater than or equal to the times difference threshold, the apparatus determining unit 132, by using the CPU 911, proceeds to the identification outputting step S629.

When the calculated difference is less than the times difference threshold, the apparatus determining unit 132, by using the CPU 911, proceeds to the trial repeating step S625.

In the trial repeating step S625, the request transmitting unit 112, by using the CPU 911, adds “1” to the number of trial times stored. The request transmitting unit 112, by using the CPU 911, returns to the trial times determining step S612.

In the identification outputting step S629, the apparatus determining unit 132, by using the CPU 911, determines the tag, having the largest number of reception times of the numbers of reception times stored by the reception storing unit 124, as the correct tag. The identification storing unit 133, by using the flash memory 920, stores the identification data of the tag determined as the correct tag by the apparatus determining unit 132. The identification outputting unit 134, by using the network communication apparatus 917, transmits the identification data of the tag determined as the correct tag by the apparatus determining unit 132, to the host computer 810.

Next, a calculation method of the times difference threshold will be described.

The probability that a certain tag responds to the identification requesting command transmitted by the request transmitting unit 112 differs depending on whether the tag is the correct tag or the wrong tag. Let p denote the response probability for the case that the tag is the correct tag. The probability P(Rₙ, x) that the correct tag responds x times to the identification requesting command of n times is obtained by the subsequent equation.

P(R_{n,x})=ₙCₓp^{x}(1−p)^{n-x}, [Equation 11]

where the number of trial times n is an integer not less than 1, the number of response times x is an integer not less than 0 and not exceeding n, and the response probability p is a real number more than 0 and less than 1.

Let q denote the response probability for the case that the tag is the wrong tag. The probability P(E_{n, x}) that the wrong tag responds x times to the identification requesting command of n times is obtained by the subsequent equation as well.

P(E_{n,x})=ₙCₓq^{x}(1−q)^{n-x}, [Equation 12]

where the number of trial times n is an integer not less than 1, the number of response times x is an integer not less than 0 and not exceeding n, and the response probability q is a real number more than 0 and less than p.

Meanwhile, it is assumed that whether each tag responds or not is independent and unrelated to the other tags.

Suppose that the tag A responds a times, and the tag B responds b times, to the identification requesting command of n times. Hereinafter, this event is denoted as “event Tⁿ_{A=a, B=b”.}

Suppose that there is one correct tag. There are the following two possibilities.

(1) the case where the tag A is the correct tag (hereinafter this is denoted as “event <<A>>”)
(2) the case where the tag B is the correct tag (hereinafter this is denoted as “event <B>>”)

Supposing that the event <<A>> has occurred, the probability that event Tⁿ _{A=a, B=b} occurs is obtained by the subsequent equation.

$$\begin{matrix}P ( {T}_{A = a , B = b}^{n} \vert 〈 〈 A 〉 〉 ) = P ( {R}_{n , a} ) \cdot P ( {E}_{n , b} ) \\ = {}_{n}^{}{C}{}_{a}^{} \cdot {}_{c}^{}{C}{}_{b}^{} \cdot {{p}^{a} ( 1 - p )}^{n - a} {{q}^{b} ( 1 - q )}^{n - b} ,\end{matrix} \qquad [ Equation 13 ]$$

where the number of trial times n is an integer not less than 1, the number of response times a and b are integers not less than 0 and not exceeding n, the response probability p is a real number more than 0 and less than 1, and the response probability q is a real number more than 0 and less than p.

In contrast to this, supposing the event <<B>> has occurred, the probability that event Tⁿ _{A=a, B=b} occurs is obtained by the subsequent equation.

$$\begin{matrix}P ( {T}_{A = a , B = b}^{n} \vert 〈 〈 B 〉 〉 ) = P ( {R}_{n , b} ) \cdot P ( {E}_{n , a} ) \\ = {}_{n}^{}{C}{}_{a}^{} \cdot {}_{c}^{}{C}{}_{b}^{} \cdot {{p}^{b} ( 1 - p )}^{n - b} {{q}^{a} ( 1 - q )}^{n - a} ,\end{matrix} \qquad [ Equation 14 ]$$

Suppose that the prior probabilities before the trial are equivalent for both events <<A>> and <<B>>, being ½. The posterior probability that the event <<A>> occurs is obtained by the subsequent equation, using Bayesian inference.

$$P ( 〈 〈 A 〉 〉 \vert {T}_{A = a , B = b}^{n} ) = \frac{P ( {T}_{A = a , B = b}^{n} \vert 〈 〈 A 〉 〉 )}{\begin{matrix}P ( {T}_{A = a , B = b}^{n} \vert 〈 〈 A 〉 〉 ) + \\ P ( {T}_{A = a , B = b}^{n} \vert 〈 〈 B 〉 〉 )\end{matrix}} \qquad [ Equation 15 ]$$

Here, a discriminant D expressed by the following equation is introduced.

$$\begin{matrix}D = \frac{P ( {T}_{A = a , B = b}^{n} \vert 〈 〈 B 〉 〉 )}{P ( {T}_{A = a , B = b}^{n} \vert 〈 〈 A 〉 〉 )} \\ = \frac{{{p}^{b} ( 1 - p )}^{n - b} {{q}^{a} ( 1 - q )}^{n - a}}{{{p}^{a} ( 1 - p )}^{n - a} {{q}^{b} ( 1 - q )}^{n - b}} \\ = {[ \frac{q ( 1 - p )}{p ( 1 - q )} ]}^{a - b}\end{matrix} \qquad [ Equation 16 ]$$

Let ε denote the tolerated wrong determination probability. It is acceptable to determine the tag A as correct when the subsequent equation is satisfied.

P( [symbol] |T_{A=a,B=b}ⁿ)≧1−ε [Equation 17]

where the tolerated wrong determination probability ε is a real number more than 0 and less than 1, and is sufficiently smaller than 1.

This is modified to obtain the subsequent equation.

$$\frac{1}{P ( 〈 〈 A 〉 〉 \vert {T}_{A = a , B = b}^{n} )} ≦ \frac{1}{1 - ɛ} \\ 1 + D ≦ \frac{1}{1 - ɛ} \\ ∴ D ≦ \frac{ɛ}{1 - ɛ} \qquad [ Equation 18 ]$$

Since the tolerated wrong determination probability ε is sufficiently smaller than 1, therefore, 1−ε≈1. Hence, it is acceptable to determine the tag A as correct when the subsequent equation is satisfied.

D=B^{a-b}≲ε [Equation 19]

where the base B is q·(1−p)/[p·(1−q)].

Now, if 0<q<p<1, then 0<B<1. Therefore, the discriminant D becomes less than 1 when the number of response times a is greater than the number of response times b. As a difference between the numbers of response times a-b gets larger, the discriminant D becomes smaller, approaching zero.

Let K denote the difference between the numbers of response times a−b. The condition that K must satisfy can be provided by the subsequent equation.

$$K {\approx }^{>} {log}_{B} ɛ = \frac{log ɛ}{log B} = \frac{- log ɛ}{log \frac{p}{1 - p} - log \frac{q}{1 - q}} \qquad [ Equation 20 ]$$

Then, by taking the K satisfying this equation as the times difference threshold, it becomes possible to ensure that a probability that it is false to determine the tag A as the correct tag is less than or equal to the tolerated wrong determination probability ε.

The smaller the times difference threshold, the higher the possibility that the determination condition is satisfied at a small number of trial times, then a time taken to determine the correct tag becomes shorter, and therefore, the possibility of determining the correct tag within the maximum number of trial times becomes higher. Hence, preferably the times difference threshold is as small as possible (within a range that the wrong determination probability is less than or equal to the tolerated wrong determination probability).

The times difference threshold calculating unit 163, by using the CPU 911, calculates a minimum integer K that satisfies the subsequent equation, to obtain the times difference threshold.

$$K > \frac{- log ɛ}{log \frac{p}{1 - p} - log \frac{q}{1 - q}} \qquad [ Equation 21 ]$$

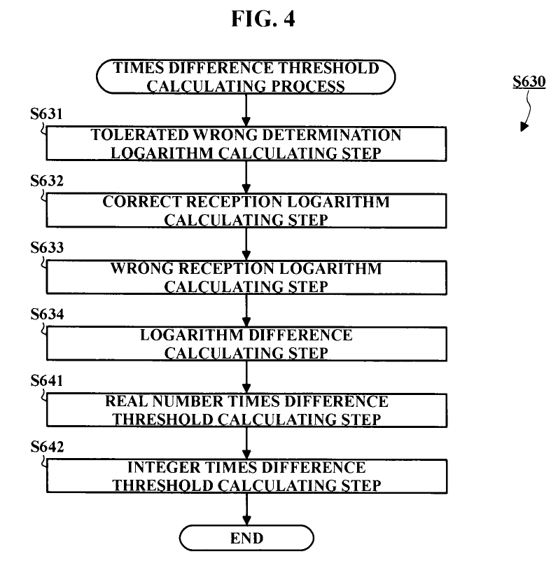

FIG. 4 illustrates a flowchart showing an example of a flow of the times difference threshold calculating process S630, in accordance with the present embodiment.

In the times difference threshold calculating process S630, the times difference threshold calculating unit 163 calculates the times difference threshold.

The times difference threshold calculating process S630 includes a tolerated wrong determination logarithm calculating step S631, a correct reception logarithm calculating step S632, a wrong reception logarithm calculating step S633, a logarithm difference calculating step S634, a real number times difference threshold calculating step S641, and an integer times difference threshold calculating step S642.

In the tolerated wrong determination logarithm calculating step S631, the times difference threshold calculating unit 163, by using the CPU 911, calculates log(ε) the logarithm of the tolerated wrong determination probability ε, based on the tolerated wrong determination probability ε stored by the tolerated wrong determination storing unit 162.

In the correct reception logarithm calculating step S632, the times difference threshold calculating unit 163, by using the CPU 911, based on the correct reception probability p stored by the correct reception probability storing unit 142, calculates 1−p, the difference obtained by subtracting the correct reception probability p from 1, calculates p/(1−p), the quotient obtained by dividing the correct reception probability p by the calculated difference 1−p, and calculates log [p/(1−p)] the logarithm of the calculated quotient p/(1−p).

In the wrong reception logarithm calculating step S633, the times difference threshold calculating unit 163, by using the CPU 911, based on the wrong reception probability q stored by the wrong reception probability storing unit 152, calculates 1−q, the difference obtained by subtracting the wrong reception probability q from 1, calculates q/(1−q), the quotient obtained by dividing the wrong reception probability q by the calculated difference 1−q, and calculates log [q/(1−q)], the logarithm of the calculated quotient q/(1−q).

Moreover, As far as the bases of the logarithms calculated by the times difference threshold calculating unit 163, in the tolerated wrong determination logarithm calculating step S631, the correct reception logarithm calculating step S632, and the wrong reception logarithm calculating step S633, are the same, the logarithms may be the natural logarithm, the common logarithm, or other logarithms to base other positive real numbers (for example, 2).

In the logarithm difference calculating step S634, the times difference threshold calculating unit 163, by using the CPU 911, calculates log [q/(1−q)]−log [p/(1−p)], the difference obtained by subtracting the logarithm log [p/(1−p)] calculated in the correct reception logarithm calculating step S632 from the logarithm log [q/(1−q)] calculated in the wrong reception logarithm calculating step S633.

In the real number times difference threshold calculating step S641, the times difference threshold calculating unit 163, by using the CPU 911, calculates log (ε)/{log [q/(1−q)]−log [p/(1−p)]}, the quotient obtained by dividing the logarithm log(ε) calculated in the tolerated wrong determination logarithm calculating step S631 by the difference calculated in the logarithm difference calculating step S634.

In the integer times difference threshold calculating step S642, the times difference threshold calculating unit 163, by using the CPU 911, obtains a minimum integer greater than the quotient log(ε)/{log [q/(1−q)]−log [p/(1−p)]} calculated in the real number times difference threshold calculating step S641, to get the times difference threshold. The times difference threshold storing unit 131, by using the flash memory 920, stores the times difference threshold calculated by the times difference threshold calculating unit 163.

For example, suppose that the tolerated wrong determination probability ε is one millionth (10 to the power of minus 6), a response probability p of the correct tag is 0.8, and a response probability q of the wrong tag is 0.2. Then the quotient calculated by the times difference threshold calculating unit 163 in the real number times difference threshold calculating step S641 is approximately 4.98. Therefore, the times difference threshold calculating unit 163 takes the minimum integer “5” greater than 4.98 as the times difference threshold.

Calculation methods of the correct reception probability and the wrong reception probability will be described next.

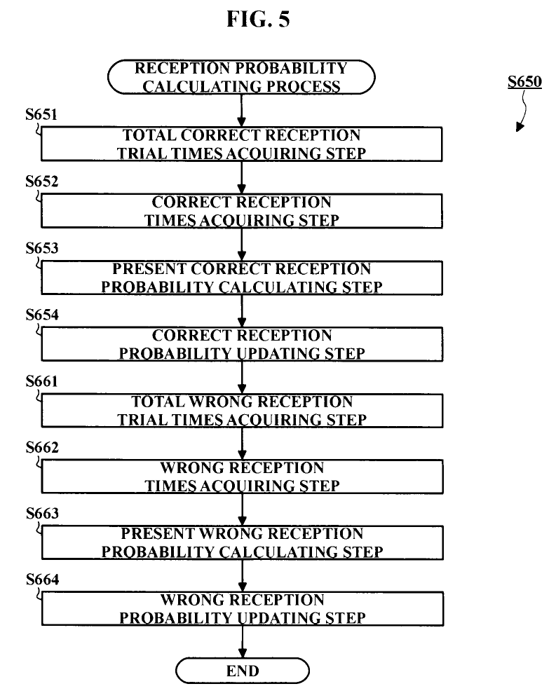

FIG. 5 illustrates a flowchart showing an example of the reception probability calculating process S650, in accordance with the present embodiment.

In the reception probability calculating process S650, the RFID reader apparatus 100 calculates the correct reception probability and the wrong reception probability.

The reception probability calculating process S650 includes a total correct reception trial times acquiring step S651, a correct reception times acquiring step S652, a present correct reception probability calculating step S653, a correct reception probability updating step S654, a total wrong reception trial times acquiring step S661, a wrong reception times acquiring step S662, a present wrong reception probability calculating step S663, and a wrong reception probability updating step S664.

In the total correct reception trial times acquiring step S651, the correct reception probability calculating unit 141, by using the CPU 911, acquires the number of trial times stored by the request transmitting unit 112, to get the total number of correct reception trial times. In the present embodiment, it is configured to take the acquired number of trial times as the total number of correct reception trial times without calculation, because it is supposed to be known in advance that the number of the correct tags is 1. However, supposing that the number of the correct tags is 2, the correct reception probability calculating unit 141, by using the CPU 911, doubles the acquired number of trial times, to get the total number of correct reception trial times. Moreover, when the number of the correct tags is not known in advance, the correct reception probability calculating unit 141, by using the CPU 911, counts the number of identification data of the tags determined as the correct tags by the apparatus determining unit 132, to acquire the number of tags determined as the correct tags by the apparatus determining unit 132, and multiplies the acquired number of the correct tags to the acquired number of trial times, to get the total number of correct reception trial times.

In the correct reception times acquiring step S652, the correct reception probability calculating unit 141, by using the CPU 911, based on the identification data of the tag determined as the correct tag by the apparatus determining unit 132, acquires the number of reception times stored by the reception storing unit 124 for that tag, to get the total number of correct reception times. However, if the number of the tags determined as the correct tags by the apparatus determining unit 132 is more than 1, the correct reception probability calculating unit 141, by using the CPU 911, acquires the numbers of reception times stored by the reception storing unit 124 for those tags, and sums up the acquired numbers of reception times, to get the total number of correct reception times.

In the present correct reception probability calculating step S653, the correct reception probability calculating unit 141, by using the CPU 911, calculates a quotient obtained by dividing the total number of correct reception times acquired in the correct reception times acquiring step S652 by the total number of correct reception trial times acquired in the total number of correct reception trial times acquiring step S651, to get a present correct reception probability.

In the correct reception probability updating step S654, the correct reception probability calculating unit 141, by using the CPU 911, adjusts the correct reception probability stored by the correct reception probability storing unit 142 based on the present correct reception probability calculated in the present correct reception probability calculating step S653.

In the total wrong reception trial times acquiring step S661, the wrong reception probability calculating unit 151, by using the CPU 911, based on the number of reception times stored by the reception storing unit 124, counts the number of tags that has responded even once to the identification requesting command transmitted by the request transmitting unit 112, in the previous trial. The wrong reception probability calculating unit 151, by using the CPU 911, subtracts 1 from the counted number, to get a number of the wrong reception tags. However, if the number of tags determined as the correct tags by the apparatus determining unit 132 is more than 1, the wrong reception probability calculating unit 151, by using the CPU 911, subtracts the number of tags determined as the correct tag by the apparatus determining unit 132 from the counted number, to get the number of the wrong reception tags.

The wrong reception probability calculating unit 151, by using the CPU 911, multiplies the calculated number of the wrong reception tags to the number of trial times stored by the request transmitting unit 112, to get a total number of wrong reception trial times.

In the wrong reception times acquiring step S662, the wrong reception probability calculating unit 151, by using the CPU 911, based on the identification data of the tag determined as the correct tag by the apparatus determining unit 132, acquires the number of reception times stored by the reception storing unit 124 for other tags (that is, the tags determined as the wrong tag by the apparatus determining unit 132), and sums up the acquired numbers of reception times, to get a total number of wrong reception times.

In the present wrong reception probability calculating step S663, the wrong reception probability calculating unit 151, by using the CPU 911, calculates a quotient obtained by dividing the total number of wrong reception times acquired in the wrong reception times acquiring step S662 by the total number of wrong reception trial times acquired in the total number of wrong reception trial times acquiring step S661, to get a present wrong reception probability.

In the wrong reception probability updating step S664, the wrong reception probability calculating unit 151, by using the CPU 911, adjusts the wrong reception probability stored by the wrong reception probability storing unit 152, based on the present wrong reception probability calculated in the present wrong reception probability calculating step S663.

The updating methods in the correct reception probability updating step S654 and the wrong reception probability updating step S664 may be other methods than the aforementioned methods. They may be the updating methods for calculating the posterior probabilities by using the Bayesian inference. Alternatively, they may be the updating methods for removing the correct reception probability or the wrong reception probability, which become old, and for storing the present correct reception probability or the present wrong reception probability calculated as the new correct reception probability or the new wrong reception probability.

A determining apparatus (the RFID reader apparatus 100) of the present embodiment is the determining apparatus that receives signal(s) transmitted by one or more communication apparatuses (the tags 821 to 823), and determines a communication apparatus serving as a communication partner (“the correct tag”), out of the communication apparatuses that have transmitted the received signals.

The determining apparatus includes a receiving apparatus that receives the signals (the radio communication apparatus 915), a processing apparatus that processes the data (the CPU 911), the signal receiving unit 121, the identification acquiring unit 122, the reception counting unit 123, and the apparatus determining unit 132.

The signal receiving unit 121, by using the receiving apparatus, receives a plurality of times each signal transmitted by one or more communication apparatuses.

The identification acquiring unit 122, by using the processing apparatus, based on the signal received by the signal receiving unit 121, acquires an identification data that identifies the communication apparatus that has transmitted the signal which is received by the signal receiving unit 121.

The reception counting unit 123, by using the processing apparatus, based on the identification data acquired by the identification acquiring unit 122, counts the number of reception times in which the signal receiving unit 121 has received the signal, for each communication apparatus identified by the identification data.

The apparatus determining unit 132, by using the processing apparatus, based on the number of reception times counted by the reception counting unit 123, calculate a difference between the number of reception times of one communication apparatus and the number of reception times of another communication apparatus (the difference in the number of reception times), compares the difference in the number of reception times calculated with a prescribed times difference threshold, and determines that the communication apparatus having more number of reception times as the communication partner (the correct tag) when the difference in the number of reception times is greater than or equal to the times difference threshold.

According to the determining apparatus (the RFID reader apparatus 100) of the present embodiment, when the difference in the number of reception times is greater than or equal to the times difference threshold, the apparatus determining unit 132 determines that the communication apparatus having the more number of reception times as the communication partner, thereby obtaining a highly reliable determination result with a simple determining method.

The determining apparatus (the RFID reader apparatus 100) of the present embodiment, further includes a storage apparatus (the flash memory 920) that stores data, the correct reception probability storing unit 142, the wrong reception probability storing unit 152, and the times difference threshold calculating unit 163.

The correct reception probability storing unit 142, by using the storage apparatus, stores a probability that the signal receiving unit 121 receives the signal transmitted by a communication apparatus serving as the communication partner (the correct tag), as the correct reception probability.

The wrong reception probability storing unit 152, by using the storage apparatus, stores a probability that the signal receiving unit 121 receives the signal transmitted by the communication apparatus not serving as the communication partner (the wrong tag), as the wrong reception probability.

The times difference threshold calculating unit 163, by using the processing apparatus (the CPU 911), calculates the times difference threshold, based on the correct reception probability stored by the correct reception probability storing unit 142 and the wrong reception probability stored by the wrong reception probability storing unit 152.

The apparatus determining unit 132, by using the processing apparatus, determines the communication apparatus serving as the communication partner, by taking the times difference threshold calculated by the times difference threshold calculating unit 163 as the prescribed times difference threshold.

According to the determining apparatus (the RFID reader apparatus 100) of the present embodiment, based on the correct reception probability and the wrong reception probability, the times difference threshold calculating unit 163 calculates the times difference threshold, thereby ensuring that the probability that the apparatus determining unit 132 makes a wrong determination is less than or equal to the prescribed value.

The determining apparatus (the RFID reader apparatus 100) of the present embodiment further includes the correct reception probability calculating unit 141.

The correct reception probability calculating unit 141, by using the processing apparatus (the CPU 911), based on the number of reception times counted by the reception counting unit 123, calculates the correct reception probability.

The correct reception probability storing unit 142, by using the storage apparatus (the flash memory 920), stores the correct reception probability calculated by the correct reception probability calculating unit 141.

According to the determining apparatus (the RFID reader apparatus 100) of the present embodiment, based on the number of reception times, the correct reception probability calculating unit 141 calculates the correct reception probability, thereby obtaining the correct reception probability matched to the actual operation status. Furthermore, based on this, the times difference threshold calculating unit 163 calculates the times difference threshold, thereby ensuring with more certainty the probability that the apparatus deciding unit 132 makes a wrong determination is less than or equal to the prescribed value.

The determining apparatus (the RFID reader apparatus 100) of the present embodiment further includes the wrong reception probability calculating unit 151.

The wrong reception probability calculating unit 151, by using the processing apparatus (the CPU 911), based on the number of reception times counted by the reception counting unit 123, calculates the wrong reception probability.

The wrong reception probability storing unit 152, by using the storage apparatus (the flash memory 920), stores the wrong reception probability calculated by the wrong reception probability calculating unit 151.

According to the determining apparatus (the RFID reader apparatus 100) of the present embodiment, based on the number of reception times, the wrong reception probability calculating unit 151 calculates the wrong reception probability, thereby obtaining the wrong reception probability matched to the actual operation status. Furthermore, based on this, the times difference threshold calculating unit 163 calculates the times difference threshold, thereby ensuring with more certainty the probability that the apparatus determining unit 132 makes a wrong determination is less than or equal to the prescribed value.

The determining apparatus (the RFID reader apparatus 100) of the present embodiment further includes a transmitting apparatus that transmits a signal (the radio communication apparatus 915) and the request transmitting unit 112.

The request transmitting unit 112, by using the transmitting apparatus, transmits a plurality of times a signal that represents a request for transmitting a signal indicating the identification data (the identification requesting command), to the communication apparatus (the tags 821 to 823).

The signal receiving unit 121, by using the receiving apparatus (the radio communication apparatus 915), receives the signal transmitted by the communication apparatus as response to the signal transmitted by the request transmitting unit 112.

According to the determining apparatus (the RFID reader apparatus 100) of the present embodiment, the signal receiving unit 121 receives the signal transmitted by the communication apparatus (the tags 821 to 823) as response to the signal transmitted by the request transmitting unit 112, thereby determining the communication partner out of the communication apparatuses present within a reach of the signal transmitted by the request transmitting unit 112.

According to the determining apparatus (the RFID reader apparatus 100) of the present embodiment, the times difference threshold calculating unit 163, by using the processing apparatus (the CPU 911), obtains an integer that satisfies the subsequent equation, as the times difference threshold.

$$K > \frac{- log ɛ}{log \frac{p}{1 - p} - log \frac{q}{1 - q}} , \qquad [ Equation 22 ]$$

where K denotes the times difference threshold calculated by the times difference threshold calculating unit 163, ε denotes a probability of the tolerated wrong determination (the tolerated wrong determination probability), p denotes the correct reception probability stored by the correct reception probability storing unit 142, and q denotes the wrong reception probability stored by the wrong reception probability storing unit 152.

According to the determining apparatus (the RFID reader apparatus 100) of the present embodiment, the probability that the apparatus determining unit 132 makes a wrong determination is ensured to be less than or equal to the tolerated probability ε.

The determining apparatus (the RFID reader apparatus 100) of the present embodiment further includes a total correct reception calculating unit (the correct reception probability calculating unit 141) and a correct reception opportunity calculating unit (the correct reception probability calculating unit 141).

The total correct reception calculating unit, by using the processing apparatus (the CPU 911), sums up the numbers of reception times counted by the reception counting unit 123 concerning the communication apparatuses (the tags 821 to 823) determined by the apparatus determining unit 132 as the communication partner (the correct tag), as a total number of correct reception times.

The correct reception opportunity calculating unit, by using the processing apparatus, sums up the number of times that the signal receiving unit 121 has had the opportunity to receive the signal concerning the communication apparatuses determined by the apparatus determining unit 132 as the communication partner (the number of trial times), as a number of correct reception opportunity times (the total number of correct reception trial times).

The correct reception probability calculating unit 141, by using the processing apparatus, calculates a quotient obtained by dividing the total number of correct reception times calculated by the total correct reception calculating unit by the number of correct reception opportunity times calculated by the correct reception opportunity calculating unit, as the correct reception probability.

According to the determining apparatus (the RFID reader apparatus 100) of the present embodiment, the correct reception probability calculating unit 141 takes the quotient obtained by dividing the total number of correct reception times by the number of correct reception opportunity times as the correct reception probability, thereby obtaining the correct reception probability matched to the actual operation status. Furthermore, based on this, the times difference threshold calculating unit 163 calculates the times difference threshold, thereby ensuring with more certainty the probability that the apparatus determining unit 132 makes a wrong determination is less than or equal to the prescribed value.

The determining apparatus (the RFID reader apparatus 100) of the present embodiment further includes a total wrong reception calculating unit (the wrong reception probability calculating unit 151) and a wrong reception opportunity calculating unit (the wrong reception probability calculating unit 151).

The total wrong reception calculating unit, by using the processing apparatus (the CPU 911), sums up the numbers of reception times counted by the reception counting unit 123 concerning the communication apparatuses (the tags 821 to 823) determined by the apparatus determining unit 132 as not serving as the communication partner (that is, determined as the wrong tag), as a total number of wrong reception times.

The wrong reception opportunity calculating unit, by using the processing apparatus, sums up the numbers of times that the signal receiving unit 121 had the opportunity to receive the signal concerning the communication apparatuses determined by the apparatus determining unit 132 as not serving as the communication partner (the number of trial times), as a number of wrong reception opportunity times (the total number of wrong reception trial times).

The wrong reception probability calculating unit 151, by using the processing apparatus, calculates a quotient obtained by dividing the total number of wrong reception total times calculated by the total wrong reception calculating unit by the number of wrong reception opportunity times calculated by the wrong reception opportunity calculating unit, as the wrong reception probability.

According to the determining apparatus (the RFID reader apparatus 100) of the present embodiment, the wrong reception probability calculating unit 151 calculates the quotient obtained by dividing the total number of wrong reception times by the number of wrong reception opportunity times as the wrong reception probability, thereby obtaining the wrong reception probability matched to the actual operation status. Furthermore, based on this, the times difference threshold calculating unit 163 calculates the times difference threshold, thereby ensuring with more certainty that the probability that the apparatus determining unit 132 makes a wrong determination is less than or equal to the prescribed value.

The determining apparatus (the RFID reader apparatus 100) of the present embodiment is implemented by executing a program for functioning a computer as the determining apparatus, by the computer.

The computer program of the present embodiment can implement the determining apparatus which is capable of obtaining a highly reliable determination result with a simple determining method.

A determining method (the determining process S610) of the determining apparatus (the RFID reader apparatus 100) of the present embodiment, for receiving signals transmitted by one or more communication apparatuses (the tags 821 to 823), and for determining the communication apparatus serving as the communication partner (the correct tag), among the communication apparatuses that transmitted the received signals, includes the following steps.

The receiving apparatus (the radio communication apparatus 915) receives a plurality of times each signal transmitted by one or more communication apparatuses (the signal receiving step S614).

The processing apparatus (the CPU 911), based on the signal received by the receiving apparatus, acquires an identification data that identifies the communication apparatus that transmitted the signal received by the receiving apparatus (the identification acquiring step S615).

The processing apparatus, based on the identification data acquired, counts a number of reception times that the receiving apparatus has received the signal, for each communication apparatus identified by the identification data (the reception counting step S617).

The processing apparatus, based on the counted number of reception times, compares the difference between the number of reception times of one communication apparatus and the number of reception times of another communication apparatus with the prescribed times difference threshold, and when the difference in the number of reception times is greater than or equal to the times difference threshold, determines the communication apparatus having the more number of reception times as the communication partner (the apparatus determining step S620).

According to the determining method of the present embodiment (the determining process S610), a highly reliable determination result is obtainable by a simple method.

For comparison, a reliability of the determining method for transmitting a plurality of times the identification requesting command, and for determining a tag in which a number of response times has attained the prescribed times most quickly, will be examined.

Let L denote A threshold value of the number of response times determined as the correct tag.

According to this determining method, the reliability is most likely to be low when a tag A is determined as the correct tag by responding L times, and a tag B is determined by a narrow margin as the wrong tag by responding (L−1) times, for a trial of n times.

Suppose that the event <<T^{N} _{A=L, B=L-1}>> has occurred, that the tag A responds L times and the tag B responds (L−1) times to n trials. Assuming the event <<A>> that the tagA is correct, a probability of the event <<T^{N} _{A=L, B=L-1}>>> occurring is given by:

$$P ( {T}_{A = L , B = L - 1}^{n} \vert 〈 〈 A 〉 〉 ) = {}_{n}^{}{C}{}_{a}^{} \cdot {}_{n}^{}{C}{}_{b}^{} \cdot {{p}^{L} ( 1 - p )}^{n - L} {{q}^{L - 1} ( 1 - q )}^{n - L + 1} . \qquad [ Equation 23 ]$$

Moreover, assuming the event <<B>> that the tag B is correct, then a probability of the event <<T^{N} _{A=L, B=L-1}>>> occurring is given by:

$$\begin{matrix}\begin{matrix}P ( {T}_{A = L , B = L - 1}^{n} \vert 〈 〈 B 〉 〉 ) = P ( {R}_{n , L - 1} ) \cdot P ( {E}_{n , L} ) \\ = {}_{n}^{}{C}{}_{a}^{} \cdot {}_{n}^{}{C}{}_{b}^{} \cdot {{p}^{L - 1} ( 1 - p )}^{n - L + 1} \\ {{q}^{L} ( 1 - q )}^{n - L} .\end{matrix} & [ Equation 24 ]\end{matrix}$$

A posterior probability of the event <<B>> that the tag B is correct is obtained by using the Bayesian inference as follows:

$$P ( 〈 〈 B 〉 〉 \vert {T}_{A = L , B = L - 1}^{n} ) = \frac{q ( 1 - p )}{p ( 1 - q ) + q ( 1 - p )} . \qquad [ Equation 25 ]$$

For example, suppose that p, the response probability of the correct tag, is 0.8, q, the response probability of the wrong tag, is 0.2. Then a posterior probability of the event <<B>> that the tag B is correct is approximately 5.9%. In other words, this is a probability that it is false to determine the tag A as the correct tag, and this value is not at all acceptable in a system requiring a high reliability.

Moreover, this value does not change even if the threshold value L or the number of trial times n has changed. As long as the system employs this determination method, increasing the number of trial times and increasing the threshold value does not contribute to an improvement of the reliability.

In contrast to this, the determining method of the determining apparatus (the RFID reader apparatus 100) of the present embodiment can secure a high reliability, for example, the probability of making the wrong determination is less than or equal to one millionth. At the same time, the reliability is increased even more by increasing the times difference threshold.

Moreover, not only simply to say that the reliability is high, but by calculating the times difference threshold based on an extent of the reliability demanded (whether it suffice to show 99% reliability, or 99.99% reliability is in demand, or 99.9999% reliability is in demand, . . . ), the reliability over the demanded level is ensured.

The process of determining the correct tag is a preliminary step in a genuine communication with the correct tag that will follow later. It is ideal for this process to make a fast determination as much as possible on the assumption that the reliability up to the demanded level is secured.

The determining apparatus (the RFID reader apparatus 100) of the present embodiment calculates the minimum times difference threshold that can secure a reliability above the demanded level, thereby determining the correct tag with possibly the least number of trial times while securing the reliability of the demanded level.

The RFID reader apparatus 100 described above provides:

(a) a reading unit (the request transmitting unit 112, the signal receiving unit 121, and the identification acquiring unit 122) that repeatedly reads the ID (the identification data);
(b) a measuring unit (the reception counting unit 123) that measures a number of reading times (the number of reception times) per ID each;
(c) a determining unit (the apparatus determining unit 132) that determines the correct ID (the correct tag) based on the number of reading times of each ID; and
(d) a finishing unit (the request transmitting unit 112) that finishes the repeating process even if the correct ID could not have been determined, based on an upper limit value of the repeating times (the maximum number of trial times).

The RFID reader apparatus 100 described above provides:

(a) a storing unit (the correct reception probability storing unit 142) that stores a probability p (the correct reception probability) that the correct ID is read;
(b) a storing unit (the wrong reception probability storing unit 152) that stores a probability q (the wrong reception probability) that the wrong ID is read; and
(c) a calculating unit (the times difference threshold calculating unit 163) that calculates a determination condition of the correct ID (the times difference threshold) based on p and q.

The RFID reader apparatus 100 described above provides:

(a) a storing unit (the reception storing unit 124) that stores a number N of communication times, a number M of tags having the correct ID, and a number T of reading times of the correct tags for the recent communication; and
(b) an updating unit (the correct reception probability calculating unit 141) that updates p based on N, M and T.

The RFID reader apparatus 100 described above provides:

(a) a storing unit (the reception storing unit 124) that stores a number N of communication times, a number E of tags having the wrong ID, and a number F of reading times of the wrong tags for the recent communication; and
(b) an updating unit (the wrong reception probability calculating unit 151) that updates q based on N, E and F.

This makes possible to determine and transmit the correct ID with a degree of accuracy (the reliability) stipulated for the use of the RFID reader apparatus 100, to the host computer 810.

In the RFID system described above, the host computer 810 issues a tag reading command to the RFID reader apparatus 100. The host computer 810 and the RFID reader apparatus 100 are connected through a network. The antenna 916 is connected to the RFID reader apparatus 100 by an antenna cable. The antenna 916 and the tags 821 to 823 communicate (exchange commands and responses) via the radio waves. The tags 821 to 823 may be plural in number. For example, only one tag need to be read, and all other tags should not be read.

The RFID reader apparatus 100 comprises a network interface unit (the network communication apparatus 917), a communication control unit (the CPU 911), a radio communication unit (the radio communication apparatus 915), an ID determining unit (the CPU 911) and so forth. The tags 821 to 823 comprise an antenna, a radio communication circuit, an ID memory storing the ID, and so forth.

The operation up to the stage of receiving the tag ID by the host computer 810 will be described.

The host computer 810 transmits an ID reading command to the RFID reader apparatus 100, through the network. The RFID reader apparatus 100 interprets signals propagated through the network at the network interface unit, acquires the ID reading command, and notifies it to the communication control unit. The communication control unit interprets the ID reading command, and according to this command, generates a communication command for reading the ID, and notifies it to the radio communication unit. The radio communication unit converts the communication command to a signal to be modulated on the radio. This signal passes through the antenna cable, which is radiated as a radio wave from the antenna 916, and received by the tags 821 to 823. The tags 821 to 823 receive the radio waves radiated by the antenna 916 at their antennas. In each of the tags 821 to 823, the radio communication circuit interprets the communication command, and reads its ID from the ID memory. The radio communication circuit converts the ID information to a wireless signal, and an antenna radiates it as the radio wave, and the antenna 916 of the RFID reader apparatus 100 receives it. The received signals go through the antenna cable, the radio communication unit restores the signals to the ID information, and the ID determining unit accumulates them.

Suppose that there are a plurality of tags 821 to 823, the system is required to read the tag 821, and not to read the tags 822 and 823. We refer to an ID of the tag that must be read as “the correct ID”, and an ID of the tag that must not be read as “the wrong ID”. For example, let us assume that A is the correct ID, and B is the wrong ID. In general, in the operation of the system, the tag 821, having the correct ID, is placed at a position sufficiently close to the antenna 916 for a fixed amount of time. On the other hand, the tags 822 and 823, having the wrong IDs, are dealt with operational measures such as keeping them sufficiently away from the antenna 916, in view of the fact that the system should not read them. Nevertheless, due to a setting problem or others, there are occasions when the antenna 916 cannot be kept sufficiently away to an extent of not capturing their radio waves. The tags 822 and 823 in motion may approach the antenna 916 instantaneously. The radio waves may reflect due to the nearby human or objects. So, the antenna 916 may capture the response waves of the tags 822 or 823 in some cases. The ID determining unit determines as wrong the wrong ID wrongly read by various causes such as these. That is, the ID determining unit inputs both the correct ID (A) and the wrong ID (B), and outputs only the correct ID (A). The network interface unit converts the correct ID (A) into a signal that propagates through the network, and transmits it to the host computer 810 through the network.

Next, a method for determining the wrong ID by the ID determining unit will be described.

The main elements of the ID determining unit are, for example, an ID storing table (the reception storing unit 124), a correct ID reading probability p storing unit (the correct reception probability storing unit 142), a wrong ID reading probability q storing unit (the wrong reception probability storing unit 152), a times difference threshold K storing unit (the times difference threshold storing unit 131), a loop times N storing unit (the request transmitting unit 112), and a maximum loop times L storing unit (the trial times storing unit 111). Now, relations of 0<K<L and 0≦q≦p≦1 are supposed. For example, p=0.8, and q=0.2. For storing IDs read out, the ID storing table has a column of storing the IDs (the identification data) and a column of storing a number of times that each ID has been read (the number of reception times). The correct ID reading probability p and the wrong ID reading probability q are expressed by the real number 0 to 1. The times difference threshold K is a constant obtained from p and q. For example, K=5. The maximum number of loop times L is a constant that stipulates a maximum number of execution time. Normally, L has a value of about 10 to 30, for example, L=20.

An operation of the ID determining unit follows below.

The ID determining unit, according to the ID reading command from the host computer 810, requests transmission of the communication commands a plurality of times to the communication control unit, receives the ID information corresponding to reading of a plurality of times, and determines the wrong ID.

To begin with, the ID determining unit issues a communication command forming request to the communication control unit.

Then, the ID determining unit receives the ID information from the tags 821 to 822, from the radio communication unit.

And then, the ID determining unit records these results to the ID storing table. The ID determining unit, for example, records them in a descending order of the numbers of reading times. That is, it stores the result having the greatest number of reading times on the first line, and the next one follows on the second line.

At this time, the number of loop times N is 1.

Then, the ID determining unit calculates a difference in the number of reading ID times. For example, if the number of the correct ID is 1, the ID determining unit calculates a difference between a first-ranking number of reading ID times and a second-ranking number of reading ID times.

After that, the ID determining unit compares the difference in the number of reading ID times with the times difference threshold K. K, for example, is a value of about 4 to 10.

When the difference in the number of reading ID times is less than the times difference threshold K, the ID determining unit compares the number of loop times N with the maximum number of loop times L. When the number of loop times N is less than the maximum number of loop times L, the ID determining unit adds 1 to the number of loop times N, and issues the communication command forming request by returning to the start.

The above operation is repeated until the difference in the number of reading ID times is greater than or equal to the times difference threshold K, or until the number of loop times N is greater than or equal to the maximum number of loop times L.

When a difference between the correct ID reading probability p and the wrong ID reading probability q is large, generally, the number of the correct ID reading times is greater than the number of the wrong ID reading times, and a difference in the number of reading times is also large. Thus, a first line on the ID storing table is the correct ID, and a second line is the wrong ID. That is, the difference in the number of reading ID times calculated by the ID determining unit is the number of the wrong ID times subtracted from the number of the correct ID times, and becomes a larger value as the loop is repeated. When the difference becomes greater than or equal to the times difference threshold K, the correct ID is decided and the operation ends. The ID determining unit determines that the first line on the ID storing table as the correct ID, and the second line and onwards are determined as the wrong IDs.

On the other hand, when the difference between the correct ID reading probability p and the wrong ID reading probability q is small, generally, the number of correct ID reading times is greater than the number of wrong ID reading times. However, this is not true in some cases. Either way, the difference in the number of reading times is also small. Thus, before the difference in the number of reading ID times worked out by the ID determining unit becomes greater than or equal to the times difference threshold K, the number of loop times N attains the maximum number of loop times L, and the operation ends before deciding the correct ID. This means that it has been impossible to determine the correct ID with satisfying the error probability required to the system. That is, this is a status in which the correct ID cannot be read sufficiently, a status in which the wrong IDs are read too much, or both. The ID determining unit notifies to the host computer 810 that it is in a status of not being able to conclude the correct ID. For example, the ID determining unit transmits to the host computer 810 all of the inputted IDs with reservation that they are not guaranteed to be the correct tag. The host computer 810 may determine the correct ID out of the received IDs based on the operational information, or may take action of re-executing or terminating the process, or others.

Next, how to work out the times difference threshold K is shown.

The times difference threshold K is decided based on the wrong probability ε required to the system (the tolerated wrong determination probability), the correct ID reading probability (the correct reception probability) p, and the wrong ID reading probability (the wrong reception probability) q.

We refer to a state that the loop has been repeated N times, that is, the process from generating the communication command to the process of updating the ID storing table has been executed N times, as “ID collection of N times”.

Suppose that a plurality of IDs are read as a result of the ID collection of N times. For example, let us assume the number of IDs read as 2. Let A and B denote the IDs read; a and b, the number of read times respectively; and D¹ₗ (A, B a, b; N), a discriminant. Further, D^{x}_{y} expresses the discriminant when a correct ID number is x and a wrong ID number is y. Moreover, it is assumed that the events are independent that the IDs A and B are read.

There are three types of combinations of A and B as shown below.

(1) A is correct ID, B is wrong ID
(2) A is wrong ID, B is correct ID
(3) A is wrong ID, B is also wrong ID

Since the correct ID reading probability p is greater than the wrong ID reading probability q, a probability of (3) is less than that of (1) and (2). Herein, (3) is ignored, and only (1) and (2) will be taken into consideration. Under this condition, the probability of (1) is defined as P₀=P(correct ID=A, wrong ID=B), and the probability of (2) is defined as P₁=P(correct ID=B, wrong ID=A). Suppose that A is the much read one. So, a≧b.

Herein, a probability density function of the correct ID reading probability is defined as ProbR, and a probability density function of the wrong ID reading probability is defined as ProbE. Assuming that ID reading is the independent event, the probability density function ProbR and the probability density function ProbE are imitated by a binomial probability density function.

The probability density function ProbR has parameters (x, N, p), where x denotes a number of times the correct ID is read, N denotes a number of reading trial times, and p denotes an average reading probability of the correct ID. At this time,

ProbR(x,N,p)=_{N}Cₓ·p^{x}(1−p)^{N-x}. [Equation 26]

The probability density function ProbE has parameters (y, N, q), where y denotes a number of times the wrong ID is read, N denotes a number of reading trial times, and q denotes an average reading probability of the wrong ID. At this time,

ProbE(y,N,q)=_{N}C_{y}·q^{y}(1−q)^{N-y}. [Equation 27]

By making a full use of the assumption that the average reading probability p of the correct ID is greater than the average reading probability q of the wrong ID, the correct ID and the wrong ID are distinguished.

The probability of (1) P₀=P(correct ID=A, wrong ID=B) is as below.

$$\begin{matrix}\begin{matrix}{P}_{0} = ProbR ( a , N , p ) \cdot ProbE ( b , N , q ) \\ = {}_{N}^{}{C}{}_{a}^{} \cdot {}_{N}^{}{C}{}_{b}^{} \cdot {{p}^{a} ( 1 - p )}^{N - a} {{q}^{b} ( 1 - q )}^{N - b}\end{matrix} & [ Equation 28 ]\end{matrix}$$

The probability of (2) P₁=P(correct ID=B, wrong ID=A) is as below.

$$\begin{matrix}\begin{matrix}{P}_{1} = ProbR ( b , N , p ) \cdot ProbE ( a , N , q ) \\ = {}_{N}^{}{C}{}_{a}^{} \cdot {}_{N}^{}{C}{}_{b}^{} \cdot {{p}^{b} ( 1 - p )}^{N - b} {{q}^{a} ( 1 - q )}^{N - a}\end{matrix} & [ Equation 29 ]\end{matrix}$$

The observed event is either one of (1) or (2). So, we get P̂₀ and P̂₁ by normalizing P₀ and P₁ to make the sum of them to be 1. That is,

$${\hat{P}}_{0} = \frac{{P}_{0}}{{P}_{0} + {P}_{1}} and {\hat{P}}_{1} = \frac{{P}_{1}}{{P}_{0} + {P}_{1}} . \qquad [ Equation 30 ]$$

P̂₀ is a probability that the determination is right that the tag A is the correct ID. In order to obtain a condition for this probability to be greater than 1−ε, we introduce the discriminant D¹₁ shown by the following equation:

$$\begin{matrix}{D}_{1}^{1} = \frac{{P}_{1}}{{P}_{0}} = \frac{{\hat{P}}_{1}}{{\hat{P}}_{0}} = \frac{1}{{\hat{P}}_{0}} - 1. \\ Thus , & [ Equation 31 ] \\ if {\hat{P}}_{0} ≧ 1 - ɛ , then {D}_{1}^{1} ≦ \frac{1}{1 - ɛ} - 1 = \frac{ɛ}{1 - ɛ} \approx ɛ . \\ Meanwhile , & [ Equation 32 ] \\ \begin{matrix}{D}_{1}^{1} = \frac{{P}_{1}}{{P}_{0}} \\ = \frac{{{p}^{b} ( 1 - p )}^{N - b} {{q}^{a} ( 1 - q )}^{N - a}}{{{p}^{a} ( 1 - p )}^{N - a} {{q}^{b} ( 1 - q )}^{N - b}} \\ = {[ \frac{q ( 1 - p )}{p ( 1 - q )} ]}^{a - b} .\end{matrix} & [ Equation 33 ]\end{matrix}$$

Therefore, one can see that distinction of the wrong ID and the correct ID is decided by a difference in the number of times the ID is read K=(a−b), and does not depend on the number of trial times N.

This indicates that an argument of the discriminant D¹₁ is a value of K only, and that a degree of reliability can be calculated just from the correct ID average reading probability p and the wrong ID average detecting probability q, which are decided in prior communication environment. Hence, the condition for completing the algorithm is that:

$${D}_{1}^{1} = {[ \frac{q ( 1 - p )}{p ( 1 - q )} ]}^{K} < ɛ \qquad [ Equation 34 ]$$

is satisfied. This equation is solved for K:

$$K > \frac{- log ɛ}{log \frac{p}{1 - p} - log \frac{q}{1 - q}} . \qquad [ Equation 35 ]$$

For example, suppose that a tolerated rate of making a wrong determination (the tolerated wrong determination probability) ε is 10 to the power of minus 6, p=0.8, and q=0.2. The right hand side of this equation is calculated to get approximately 4.98, thus a minimum integer K that satisfy the condition is 5.

The RFID reader apparatus described above, in order to deal with the cases of the changes in the correct ID reading rate p and the wrong ID reading rate q, feeds the read results back to p and q, and re-calculates the times difference threshold K.

For example, the ID determining unit has an ID storing table (the reception storing unit 124), and an execution log table (an execution result storing unit). The ID determining unit stores the following as variables: the maximum number of loop times (the maximum number of trial times) L, the times difference threshold K, the number of loop times (the number of trial times) N, the number of correct ID tags M, the total number of correct ID reading times T (the total number of correct reception times), the number of wrong ID tags E, the total number of wrong ID reading times F (the total number of wrong reception times), a correct ID reading rate (the correct reception probability) p, and the wrong ID reading rate (the wrong reception probability) q.

The maximum number of loop times L is set to a constant sufficiently larger in value than the times difference threshold K, for example, 20, which is an experimentally reasonable value. Moreover, for example, the times difference threshold K is set to 5 at first, and the expected number of tags of the correct IDs is always set to 2. For example, the host computer 810 issues the tag reading commands 4 times, and by using its result, the ID determining unit updates the K value.

As a result of performing the correct ID determining process by the ID determining unit, for one tag reading command, for example, 3 IDs are read in a loop of 10 times, and the number of reading times of them are 9, 7 and 2, respectively. Since a difference between the number of reading times of the second ID and the number of reading times of the third ID is greater than or equal to the times difference threshold K=5, the ID which is read 9 times and the ID which is read 7 times are determined as the correct ID, and the ID which is read 2 times is determined as the wrong ID. At this time, the number of the correct ID tags M=2, and the sum of the number of reading times of both correct ID is 9+7=16, which remains as the T value. Since one wrong ID tag is detected, E=1. Since this is detected two times, the sum of the wrong ID reading times F=2.

Such a result is worked out for each tag reading command from the host computer 810, to be stored on the execution log table. The first line on this table is a result of the first tag reading command, and the second line is a result of the second tag reading command. For example, this table records the results of 4 times.

The ID determining unit works out the correct ID reading rate (the correct reception probability) p by dividing a total sum (ΣT) of the correct ID read total times (the total number of correct reception times) T by a total number (Σ(N×M)) that could have been read in the ideal condition (the reading rate 100%). That is, p=ΣT/Σ(N×M). For example, assuming that the total number of correct ID reading times T is 16 at the first time, 13 at the second time, and 10 at the third time, and 13 at the fourth time, the ID determining unit calculates the total sum of T, to get ΣT=52. Moreover, for example, assuming that the number of loop times N is 10 at the first time, 7 at the second time, 5 at the third time, 8 at the fourth time, and that the correct ID tag number M are all the same of 2 from the first time to the fourth time, the ID determining unit calculates the total number of the opportunities that the correct ID could have been read, to get Σ(N×M)=60. The ID determining unit divides the total sum of T by the total number of the opportunities that the correct ID could have been read, to get the correct ID reading rate p=52/60=0.87.

The ID determining unit works out the wrong ID reading rate q by dividing a total sum (Σ(F/E)) of the reading number per single wrong tag (F/E) by a total number (ΣN) of the reading opportunities. That is, q=(Σ(F/E))/ΣN. For example, assuming that the total number of wrong ID reading times F is 2 at the first time, 2 at the second time, 0 at the third time, 1 at the fourth time, and that the number of wrong ID tags is 1 at the first time, 2 at the second time, 0 at the third time, 1 at the fourth time, the ID determining unit divides the total numbers of wrong ID reading times F by the numbers of wrong ID tags E, to get 2 at the first time, 1 at the second time, none at the third time, and 1 at the fourth time, as the reading number per single tag (F/E) for each round, and sum them up to obtain the total sum Σ(F/E)=4. The ID determining unit divides the total sum Σ(F/E) by the total sum ΣN=30 of the number of loop times N, to obtain the wrong ID reading rate q=4/30=0.13.

The ID determining unit, based on the calculated correct ID reading rate and the wrong ID reading rate, calculates a minimum times difference threshold K, for which the probability of making the wrong determination is less than or equal to the tolerated rate of making the wrong determination (the tolerated wrong determination probability) ε, and updates the stored times difference threshold by taking this as the optimized value.

Meanwhile, the configuration may be as follows: the correct reception probability calculating unit 141 and the wrong reception probability calculating unit 151 calculates the correct reception probability p and the wrong reception probability q by using the Bayesian inference.

For example, the correct reception probability storing unit 142, by using the flash memory 920, stores probabilities of every 1% of the correct reception probability, that is, the probabilities that the correct reception probability is 1%, 2%, . . . , and 99%, as a probability distribution of the correct reception probability. For example, at the initial state, the correct reception probability storing unit 142 stores (2x/99) as a probability that the correct reception probability is x. The correct reception probability storing unit 142, by using the CPU 911, based on the probability distribution of the correct reception probability p stored, calculates an expected value of the correct reception probability, and by using the flash memory 920, stores the calculated average value as the correct reception probability p.

As a result of the trial, for example, suppose that a tag determined as the correct tag by the apparatus determining unit 132 has responded a times for n times trial. The correct reception probability calculating unit 141, by using the CPU 911, updates the probability distribution of the correct reception probability stored by the correct reception probability storing unit 142. For example, let pₓ denote the probability stored by the correct reception probability storing unit 142 that the correct reception probability is x %. The correct reception probability calculating unit 141, by using the CPU 911, calculates the subsequent equation, to obtain Pₓ+, the probability before the normalization.

pₓ⁺=x^{a}(1−x)^{n-a}pₓ [Equation 36]

The correct reception probability calculating unit 141, by using the CPU 911, sums up Pₓ+, the calculated probabilities before the normalization, and calculates a quotient obtained by dividing each pₓ+, the calculated probability before the normalization, by Σp+, the calculated total values, to get the probabilities after updating. The purpose of this is to make the total of the probabilities after updating to 1. The correct reception probability storing unit 142, by using the flash memory 920, stores the probabilities after updating calculated by the correct reception probability calculating unit 141 as the probability distribution of the correct reception probability, and by using the CPU 911, calculates the expected value of the correct reception probability, and by using the flash memory 920, stores it as the correct reception probability p.

The configuration for the wrong reception probability may be similar. For example, the wrong reception probability storing unit 152, by using the flash memory 920, stores probabilities of every 1% of the wrong reception probability, that is, the probabilities that the wrong reception probability is 1%, 2%, . . . , and 99%, as a probability distribution of the wrong reception probability. For example, at the initial state, the wrong reception probability storing unit 152 stores [2(1−x)/99] as a probability that the wrong reception probability is x. The wrong reception probability storing unit 152, by using the CPU 911, calculates an expected value of the wrong reception probability, by using the flash memory 920, and stores it as the wrong reception probability q.

As a result of the trial, for example, suppose that a tag determined as the wrong tag by the apparatus determining unit 132 has responded b times for n times trial. The wrong reception probability calculating unit 151, by using the CPU 911, updates the probability distribution of the wrong reception probability stored by the wrong reception probability storing unit 152. For example, let qₓ denote the probability stored by the wrong reception probability storing unit 152 that the wrong reception probability is x %. The wrong reception probability calculating unit 151, by using the CPU 911, calculates the subsequent equation, to get qₓ+, the probabilities before the normalization.

qₓ⁺=x^{b}(1−x)^{n-b}qₓ [Equation 37]

The wrong reception probability calculating unit 151, by using the CPU 911, sums up qₓ+, the calculated probabilities before normalization, calculates a quotient obtained by dividing each qₓ+, the calculated probability before normalization by Σq+, the calculated total value, to get the probabilities after updating. The wrong reception probability storing unit 152, by using the flash memory 920, stores the probabilities after updating calculated by the wrong reception probability calculating unit 151 as the probability distribution of the wrong reception probability, and by using the CPU 911, calculates an expected value of the wrong reception probability, and by using the flash memory 920, stores it as the wrong reception probability q.

Moreover, the configuration that the correct reception probability and the wrong reception probability are updated only when the correct tag has been determined, may cause overestimation of the correct reception probability and underestimation of the wrong reception probability, because of accumulation of the only data in a good reception environment.

For this reason, the configuration as follows is preferable: the correct reception probability calculating unit 141 and the wrong reception probability calculating unit 151 update the correct reception probability and the wrong reception probability also when the apparatus determining unit 132 has not determined the correct tag.

For example, when a tag cannot be determined as the correct tag with certainty but the probability that the tag is the correct tag is higher than the probability that the tag is the wrong tag, the correct reception probability calculating unit 141 treats the tag as the correct tag, and updates the correct reception probability. And when a tag cannot be determined as the wrong tag but the probability that the tag is the wrong tag is higher than the probability that the tag is the correct tag, the wrong reception probability calculating unit 151 treats the tag as the wrong tag, and updates the wrong reception probability.

Alternatively, the configuration may be as follows: when tags cannot be determined neither as the correct tag nor the wrong tag, the correct reception probability calculating unit 141 treats all the tags as the correct tag, and updates the correct reception probability. But the wrong reception probability calculating unit 151 treats all the tags as the wrong tag, and updates the wrong reception probability. this configuration underestimates the correct reception probability, and overestimates the wrong reception probability than they actually are. However, the reliability of determination is secured.

### Second Embodiment

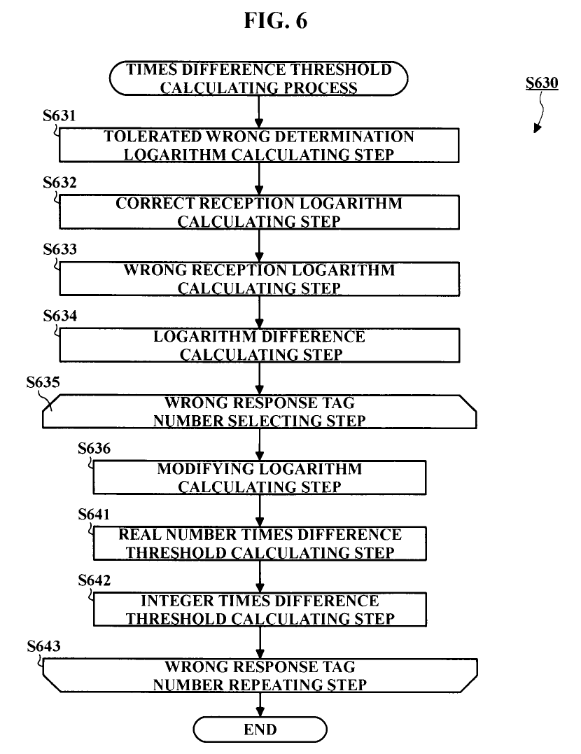

The second embodiment will be described with reference to FIGS. 6 to 8.

The identical reference numerals are used for the portions that are common to the RFID reader apparatus 100 described in the first embodiment, and their explanations are omitted herewith.

The first embodiment has described a case in which there is one correct tag and two tags have responded for a trial of n times.

The present embodiment will describe the case in which there is one correct tag and three or more tags have responded for a trial of n times.

That is, assuming that the event Tⁿ_{Ai=ai|i=0 . . . me} has occurred that (mₑ+1) number of tags respond for a trial of n times, and tag A₀ responds a₀ times, tag A₁ responds a₁ times, tag A₂ responds a₂ times, . . . , and tag Aₘₑ responds aₘₑ times, we consider the event <<Aⱼ>> that the tag A: is correct (where j is an integer not less than 0 and not exceeding mₑ).

The probability that the event Tⁿ_{Ai=ai|i=0 . . . me} occurs assuming the event <<Aⱼ>> has occurred, is given by the subsequent equation.

$$\begin{matrix}\begin{matrix}P ( {T}_{{A}_{i} = {a}_{i} \vert i = 0 … {m}_{e}}^{n} \vert 〈 〈 {A}_{j} 〉 〉 ) = P ( {R}_{n , {a}_{j}} ) \frac{{\prod }_{i = 0}^{{m}_{e}} P ( {E}_{n , {a}_{i}} )}{P ( {E}_{n , {a}_{j}} )} \\ = {\prod }_{i = 0}^{{m}_{e}} {}_{n}^{}{C}{}_{{a}_{i}}^{} \cdot {{p}^{{a}_{j}} ( 1 - p )}^{n - {a}_{j}} \\ {{q}^{\sum {a}_{i} - {a}_{j}} ( 1 - q )}^{n \cdot {m}_{e} - \sum {a}_{i} + {a}_{j}} ,\end{matrix} & [ Equation 38 ]\end{matrix}$$

where the number of trial times n is an integer not less than 1, mₑ is a number of wrong tags out of the responded tags, i is an integer not less than 0 and not exceeding mₑ, the number of response times aᵢ is an integer not less than 0 and not exceeding n, the response probability p is a real number more than 0 and less than 1, and the response probability q is a real number more than 0 and less than p.

Suppose that the prior probabilities before the trial are equivalent for all events <<Aⱼ>> of mₑ+1 number of tags, being 1/(mₑ+1) The posterior probability of the event <<Aⱼ>> is obtained by the subsequent equation, based on Bayesian inference.

$$P ( 〈 〈 {A}_{j} 〉 〉 \vert {T}_{{A}_{i} = {a}_{i} \vert i = 0 … {m}_{e}}^{n} ) = \frac{P ( {T}_{{A}_{i} = {a}_{i} \vert i = 0 … {m}_{e}}^{n} \vert 〈 〈 {A}_{j} 〉 〉 )}{{\sum }_{k = 0}^{e} P ( {T}_{{A}_{i} = {a}_{i} \vert i = 0 … {m}_{e}}^{n} \vert 〈 〈 {A}_{k} 〉 〉 )} \qquad [ Equation 39 ]$$

Then, we introduce the discriminant D expressed by the following equation.

$$\begin{matrix}D = \frac{{\sum }_{k = 0}^{e} P ( {T}_{{A}_{i} = {a}_{i} \vert i = 0 … {m}_{e}}^{n} \vert 〈 〈 {A}_{k} 〉 〉 )}{P ( {T}_{{A}_{i} = {a}_{i} \vert i = 0 … {m}_{e}}^{n} \vert 〈 〈 {A}_{j} 〉 〉 )} - 1 \\ = {[ \frac{q ( 1 - p )}{p ( 1 - q )} ]}^{{a}_{j}} {\sum }_{k = 0}^{{m}_{e}} {[ \frac{p ( 1 - q )}{q ( 1 - p )} ]}^{{a}_{k}} - 1 \\ = {B}^{{a}_{j}} {\sum }_{k = 0}^{{m}_{e}} {B}^{- {a}_{k}} - 1 ,\end{matrix} \qquad [ Equation 40 ]$$

where the base B is q·(1−p)/[p·(1−q)].

Now, since 0<B<1, if a₁≧aₘ, then, B^{-a}ₗ≧B^{-a}ₘ. Let aₘₐₓ denote the largest one of the numbers of response times aᵢ (i=0 . . . mₑ, i≢j) of mₑ tags except for the tag Aⱼ. The subsequent equation is satisfied.

$${\sum }_{k = 0}^{{m}_{e}} {B}^{- {a}_{k}} - {B}^{- {a}_{j}} ≦ {m}_{e} \cdot {B}^{- {a}_{max}} \\ ∴ D ≦ {m}_{e} {B}^{{a}_{j} - {a}_{max}} \qquad [ Equation 41 ]$$

The tag Aⱼ may be determined as correct only when the posterior probability of the event <<Aⱼ>> is 1−ε or more. This condition is satisfied if a value of the discriminant D is smaller than the tolerated wrong determination probability ε. The tolerated wrong determination probability ε is a real number more than 0 and less than 1, and is supposed to be sufficiently smaller than 1.

Then, let K denote the difference between the number of response times of the tag having the largest number of response times and the number of response times of the tag having the second-largest number of response times among the responded tags. Then we get the subsequent equation showing the condition that K=aⱼ−aₘₐₓ must satisfy.

$$\begin{matrix}K {\approx }^{>} {log}_{B} \frac{ɛ}{{m}_{e}} \\ = \frac{log ɛ - log {m}_{e}}{log B} \\ = \frac{log {m}_{e} - log ɛ}{log \frac{p}{1 - p} - log \frac{q}{1 - q}}\end{matrix} \qquad [ Equation 42 ]$$

The times difference threshold calculating unit 163, by using the CPU 911, calculates the smallest integer K satisfying the following equation, as the times difference threshold.

$$K > \frac{log {m}_{e} - log ɛ}{log \frac{p}{1 - p} - log \frac{q}{1 - q}} \qquad [ Equation 43 ]$$

The smallest integer K satisfying this equation changes depending on the number of wrongly responded tags mₑ. The larger the mₑ, the greater K gets.

FIG. 6 illustrates a flowchart showing an example of a flow of the times difference threshold calculating process S630, in accordance with the present embodiment.

In the times difference threshold calculating process S630, the times difference threshold calculating unit 163 calculates the times difference threshold for the respective cases corresponding to the number of wrongly responded tags.

The times difference threshold calculating process S630, in addition to the steps described in the first embodiment, further includes a wrong response tag number selecting step S635, a modifying logarithm calculating step S636, and a wrong response tag number repeating step S643.

In the wrong response tag number selecting step S635, the times difference threshold calculating unit 163, by using the CPU 911, selects one integer out of the integers of a prescribed range (for example, from 1 to 10) successively, as the number of wrongly responded tags mₑ.

In the modifying logarithm calculating step S636, the times difference threshold calculating unit 163, by using the CPU 911, calculates log(mₑ), the logarithm of the number of wrongly responded tags mₑ selected in the wrong response tag number selecting step S635. Meanwhile, it may be configured that: the times difference threshold calculating unit 163 stores by using the flash memory 920, log(m), the logarithms of integers m within the prescribed range, calculated in advance, and acquires by using the CPU 911, log(mₑ) among the stored log(m)

In the real number times difference threshold calculating step S641, the times difference threshold calculating unit 163, by using the CPU 911, calculates the difference log(ε)−log(mₑ) obtained by subtracting the log(mₑ) calculated in the modifying logarithm calculating step S636 from the log(ε) calculated in the tolerated wrong determination logarithm calculating step S631. The times difference threshold calculating unit 163, by using the CPU 911, calculates the quotient {log(ε)−log(mₑ)}/{log [q/(1−q)]−log [p/(1−p)]} obtained by dividing the calculated difference by the difference log [q/(1−q)]−log [p/(1−p)] calculated in the logarithm difference calculating step S634.

In the integer times difference threshold calculating step S642, the times difference threshold calculating unit 163, by using the CPU 911, works out the smallest integer greater than the quotient {log(ε)−log(mₑ)}/{log [q/(1−q)]−log [p/(1−p)] calculated in the real number times difference threshold calculating step S641, as the times difference threshold. The times difference threshold storing unit 131, by using the flash memory 920, stores the times difference threshold calculated by the times difference threshold calculating unit 163 as the times difference threshold corresponding to the number of wrongly responded tags selected by the times difference threshold calculating unit 163 in the wrong response tag number selecting step S635.

In the wrong response tag number repeating step S643, the times difference threshold calculating unit 163, by using the CPU 911, determines whether all integers within the prescribed range has been selected in the wrong response tag number selecting step S635.

When determined that there is an integer which has not been selected yet, then the times difference threshold calculating unit 163, by using the CPU 911, returns to the wrong response tag number selecting step S635, and selects the next integer.

When determined that all integers within the prescribed range have been selected, then the times difference threshold calculating unit 163, by using the CPU 911, ends the times difference threshold calculating process S630.

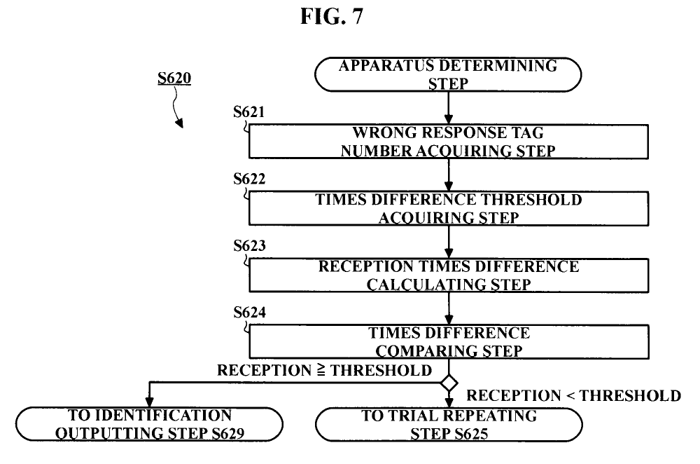

FIG. 7 illustrates a flowchart showing an example of a flow of the apparatus determining step S620, in accordance with the present embodiment.

The apparatus determining step S620 is one of the steps of the determining process S610 described in the first embodiment. The apparatus determining step S620 includes a wrong response tag number acquiring step S621, a times difference threshold acquiring step S622, a reception times difference calculating step S623, and a times difference comparing step S624.

In the wrong response tag number acquiring step S621, the apparatus determining unit 132, by using the CPU 911, based on the numbers of reception times stored by the reception storing unit 124, counts the number of tags that have responded even once to the identification requesting command transmitted by the request transmitting unit 112 in the previous trial. The apparatus determining unit 132, by using the CPU 911, calculates the difference obtained by subtracting the number of correct tags known in advance (for example, 1) from the counted number of tags, as the number of wrongly responded tags.

In the times difference threshold acquiring step S622, the apparatus determining unit 132, by using the CPU 911, acquires the times difference threshold corresponding to the number of wrongly responded tags acquired in the wrong response tag number acquiring step S621, out of the times difference thresholds stored by the times difference threshold storing unit 131.

In the reception times difference calculating step S623, the apparatus determining unit 132, by using the CPU 911, based on the numbers of reception times stored by the reception storing unit 124, works out the tag having the largest number of reception times and the tag having the second-largest number of reception times, and calculates the difference obtained by subtracting the number of reception times of the tag having the second-largest number of reception times from the number of reception times of the tag having the largest number of reception times, as the difference in the number of reception times.

In the times difference comparing step S624, the apparatus determining unit 132, by using the CPU 911, compares the difference in the number of reception times calculated in the reception times difference calculating step S623 with the times difference threshold acquired in the times difference threshold acquiring step S622.

When the difference in the number of reception times is greater than or equal to the times difference threshold, then the apparatus determining unit 132, by using the CPU 911, proceeds to the identification outputting step S629.

When the difference in the number of reception times is less than the times difference threshold, then the apparatus determining unit 132, by using the CPU 911, proceeds to the trial repeating step S625.

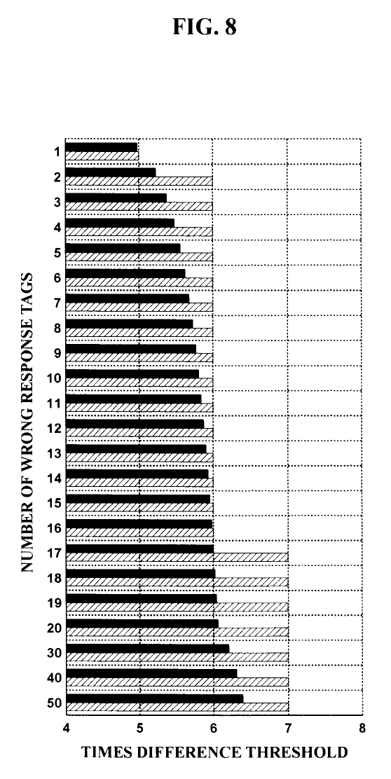

FIG. 8 illustrates a drawing showing an example of times difference threshold calculated by the times difference threshold calculating unit 163, in accordance with the present embodiment.

The vertical axis indicates the number of wrongly responded tags. The horizontal axis indicates the times difference threshold. The dark bars show the quotients calculated by the times difference threshold calculating unit 163 in the real number times difference threshold calculating step S641, and the shaded bars show the times difference threshold calculated by the times difference threshold calculating unit 163 in the integer times difference threshold calculating step S642.

In this example, the times difference threshold is calculated based on the assumption as follows: the response probability of the correct tag p is 0.8, and the response probability of the wrong tag q is 0.2, and the tolerated error ε is one millionth.

As this example indicates, when the number of wrongly responded tags increases, the times difference threshold calculated by the times difference threshold calculating unit 163 also increases. But an increasing manner of the times difference threshold is gentle.

When the number of wrongly responded tags is too large, there are liable to be some operational problems, such as the inventory location of tags being too close to the RFID reader apparatus 100, for example. Without such an operational problem, the number of wrongly responded tags will not get so large.

Hence, the configuration may be as follows: the practical upper limit of the number of the wrongly responded tags (for example, 10) is defined in advance; the times difference threshold calculating unit 163, by using the CPU 911, calculates the times difference threshold corresponding to the upper limit of the number of wrongly responded tags defined in advance; and the apparatus determining unit 132, by using the CPU 911, determines the correct tag by using the times difference threshold corresponding to the upper limit of the number of wrongly responded tags, regardless of the actual number of wrongly responded tags.

Also, the configuration may be as follows: in addition to the configuration above, a wrong response tag number determining unit is installed; the wrong response tag number determining unit, by using the CPU 911, based on the numbers of reception times stored by the reception storing unit 124, counts the number of wrongly responded tags, and compares the counted number of wrongly responded tags with the upper limit defined in advance, and when the counted number of wrongly responded tags is larger than the upper limit, transmits a warning message to the host computer 810 by using the network communication apparatus 917.

In the determining apparatus of the present embodiment (the RFID reader apparatus 100), the times difference threshold calculating unit 163, by using the processing apparatus (the CPU 911), calculates an integer that satisfies the subsequent equation, as the times difference threshold.

$$K > \frac{log {m}_{e} - log ɛ}{log \frac{p}{1 - p} - log \frac{q}{1 - q}} , \qquad [ Equation 44 ]$$

where K denotes the times difference threshold calculated by the times difference threshold calculating unit 163; ε denotes the probability of the tolerated wrong determination (the tolerated wrong determination probability); p denotes the correct reception probability stored by the correct reception probability storing unit 142; q denotes the wrong reception probability stored by the wrong reception probability storing unit 152; and mₑ denotes the number of communication apparatuses not serving as the communication partner (the wrong tags), among the communication apparatuses that transmitted the signals received by the signal receiving unit 121.

According to the determining apparatus of the present embodiment (the RFID reader apparatus 100), the probability that the apparatus determining unit 132 makes the wrong determination is ensured to be less than or equal to the tolerance probability ε.

In the RFID reader apparatus 100 described above, let D¹_{E} denote the discriminant in the case of one correct ID and an E number of wrong IDs are present. The condition for completing the algorithm is that the value of the discriminant D¹_{E} is smaller than the tolerated wrong determination probability ε.

Herein, a₀ denotes the number of reading times of the ID having the largest number (ID_{O}), a₁ denotes the number of reading times of the ID having the second-largest number (ID₁), . . . , and a_{E} denotes the number of reading times of the ID having the smallest number (ID_{E}). That is, a₀≧a₁≧a₂≧ . . . ≧a_{E}. We suppose that the correct ID is any one of these. The number of conceivable events is E+1. The events and the probabilities of them are as below.

(1) ID₀ is the correct ID, and others are the wrong IDs:

P₀=ProbR(a₀,N,p)·ProbE(a₁,N,q)·ProbE(a₂,N,q) . . . ProbE(a_{E},N,q) [Equation 45]

(2) ID₁ is the correct ID, and others are the wrong IDs:

P₁=ProbE(a₀,N,q)·ProbR(a₁,N,p)·ProbE(a₂,N,q) . . . ProbE(a_{E},N,q) [Equation 46]

(i+1) IDᵢ is the correct ID, and the others are the wrong IDs:

$${P}_{i} = ProbE ( {a}_{0} , N , q ) \cdot … \cdot ProbE ( {a}_{i - 1} , N , q ) \cdot ProbR ( {a}_{i} , N , p ) \cdot ProbE ( {a}_{i + 1} , N , q ) \cdot … \cdot ProbE ( {a}_{E} , N , q ) \\ … \qquad [ Equation 47 ]$$

(E+1) ID_{E} is the correct ID, and the others are the wrong IDs:

P_{E}=ProbE(a₀,N,q) . . . ProbE(a_{E-2},N,q)·ProbE(a_{E-1},N,q)·ProbR(a_{E},N,p) [Equation 48]

Among these events, the one having the highest occurrence probability is the event (1) where the ID₀ having the largest number of reading times is the correct ID. The algorithm can finish when the probability that this event occurs is greater than or equal to 1−ε.

When a₂ is sufficiently smaller than a₁, we can ignore a₂ and the followings. So, the case can be treated as the case of the two IDs. The determination becomes difficult when the second-largest number of reading times and the following ones are close. The most extreme case is when a₁=a₂= . . . =a_{E}. If the determination is correct for this case, the determinations are also correct for the remaining cases, when the second-largest number of the reading times and the following ones are moderately scattering. Hence, we assume the most extreme case, when a₁=a₂= . . . =a_{E}.

Herein, we introduce the discriminant D¹_{E} as follows:

$$\begin{matrix}{D}_{E}^{1} = \frac{{P}_{1} + {P}_{2} + … + {P}_{E}}{{P}_{0}} \\ = \frac{1 - {\hat{P}}_{0}}{{\hat{P}}_{0}} \\ = \frac{1}{{\hat{P}}_{0}} - 1.\end{matrix} \qquad [ Equation 49 ]$$

Since a₁=a₂= . . . =a_{E}, P₁=P₂= . . . P_{E}. Therefore,

$$\begin{matrix}{D}_{E}^{1} = \frac{E \cdot {P}_{1}}{{P}_{0}} \\ = E \cdot {[ \frac{q ( 1 - p )}{p ( 1 - q )} ]}^{{a}_{0} - {a}_{1}} .\end{matrix} \qquad [ Equation 50 ]$$

This shows that the discrimination between the wrong ID and the correct ID is determined by K=(a₀−a₁), the deference between the number of times the first-ranking ID is read and that of the second-ranking ID, and E, the number of tags having the wrong ID, without depending on the number of trial times N.

Therefore, the parameters of the discriminant D¹_{E} are not a₀ and a₁ but K. The degree of reliability can be calculated based only on the average rate p of reading the correct ID and the average probability q of detecting the wrong ID, which are determined based on the prior communication environment. Hence, the condition for completing the algorithm is that the following equation is satisfied:

$${D}_{E}^{1} = E \cdot {[ \frac{q ( 1 - p )}{p ( 1 - q )} ]}^{K} < ɛ . \qquad [ Equation 51 ]$$

When solving this for K, we get:

$$K > \frac{log E - log ɛ}{log \frac{p}{1 - p} - log \frac{q}{1 - q}} . \qquad [ Equation 52 ]$$

### Third Embodiment

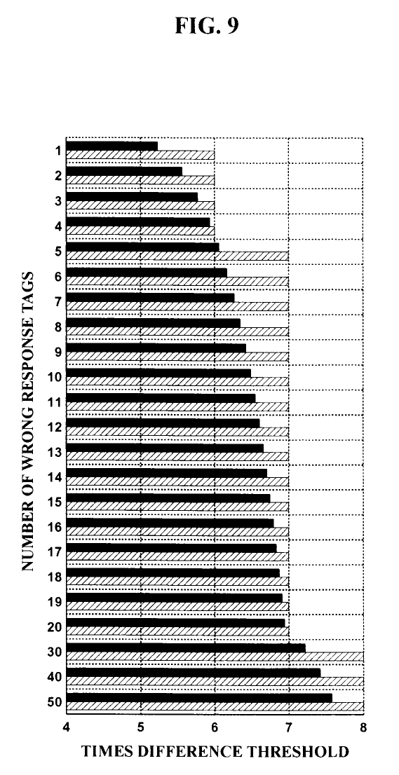

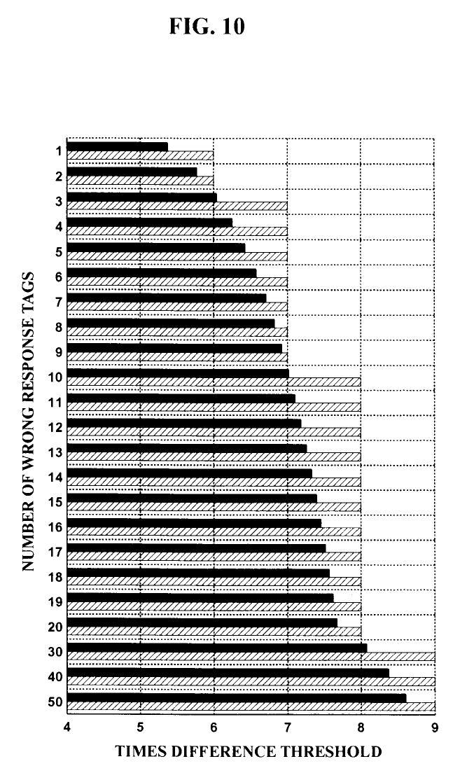

The third embodiment will be described with reference to FIGS. 9 to 10.

The identical reference numerals are used for the portions that are common to the RFID reader apparatus 100 described in the first and second embodiments, and their explanations are omitted herewith.

In the first and second embodiments, the description is about the operation modes where the number of the correct tags is 1.

In the present embodiment, the description below is about operation modes where the number of the correct tags is a prescribed number not less than 2.

Here, suppose that the number of correct tags is mᵣ, and (mᵣ+mₑ) number of tags have responded for a trial of n times. That is, the number of wrongly responded tags is mₑ. We consider the events <Aⱼ|jεR>> that the tags Aⱼ₁ to Aⱼₘᵣ are correct (where j₁ to jₘᵣ are integers not less than 0 and not exceeding mᵣ+mₑ, being different from each other; the set R is an finite set; and the elements of the set R are the mᵣ number of j₁ to jₘᵣ), assuming that the event Tⁿ_{Ai=ai|i=0 . . . mr+me-1} has occurred that the numbers of response times that the tags Aᵢ have responded (where i is an integer not less than 0 and not exceeding mᵣ+mₑ) are aᵢ, respectively.

The following equation gives the probabilities that the event Tⁿ_{Ai=ai|i=0 . . . mr+me-1} occurs assuming the event <<Aⱼ|jεR>> has occurred:

$$P ( {T}_{{A}_{i} = {a}_{i} \vert i = 0 … {m}_{r} + {m}_{e} - 1}^{n} \vert 〈 〈 {A}_{j} \vert j ∈ R 〉 〉 ) = {\prod }_{i ∈ R} P ( {R}_{n , {a}_{i}} ) \cdot {\prod }_{i ∉ R} P ( {E}_{n , {a}_{i}} ) = {\prod }_{i} {}_{n}^{}{C}{}_{{a}_{i}}^{} \cdot {{p}^{{\sum }_{i ∈ R} {a}_{i}} ( 1 - p )}^{n \cdot {m}_{r} - {\sum }_{i ∈ R} {a}_{i}} \cdot {{q}^{{\sum }_{i ∉ {R}^{{a}_{i}}} {a}_{i}} ( 1 - q )}^{n \cdot {m}_{e} - {\sum }_{i ∉ R} {a}_{i}} , \qquad [ Equation 53 ]$$

where the number of trial times n is an integer not less than 1; mᵣ is the number of correct tags; mₑ is the number of wrong tags among the responded tags; i is an integer not less than 0 and not exceeding (mᵣ+mₑ); the numbers of response times aᵢ are integers not less than 0 and not exceeding n; the elements of the set R are the mᵣ number of subscripts of correct tags; the response probability p is a real number more than 0 and less than 1; and the response probability q is a real number more than 0 and less than p.

Hereinbelow, S_{X, y} denotes a set of all the sets Y, where the sets Y are subsets of the set X, and the numbers of the elements of the sets Y are y. Suppose that the set Z is a set, the elements of which are integers not less than 0 and not exceeding (mᵣ+mₑ) The number of elements of the set S_{Z, mr} is ₘᵣ₊ₘₑCₘᵣ.

Suppose that the prior probabilities before the trial are all equal for the ₘᵣ₊ₘₑ Cₘᵣ number of the events <<Aⱼ|jεY>> (where YεS_{Z, mr}), the posterior probability of the events <<Aⱼ|jεR>> can be obtained by the subsequent equation, based on Bayesian inference.

$$P ( 〈 〈 {A}_{j} \vert j ∈ R 〉 〉 \vert {T}_{{A}_{i} = {a}_{i} \vert i = 0 … {m}_{r} + {m}_{e} - 1}^{n} ) = \frac{P ( {T}_{{A}_{i} = {a}_{i} \vert i = 0 … {m}_{r} + {m}_{e} - 1}^{n} \vert 〈 〈 {A}_{j} \vert j ∈ R 〉 〉 )}{{\sum }_{Y ∈ {S}_{Z , {m}_{r}}} P ( {T}_{{A}_{i} = {a}_{i} \vert i = 0 … {m}_{r} + {m}_{e} - 1}^{n} \vert 〈 〈 {A}_{k} \vert k ∈ Y 〉 〉 )} \qquad [ Equation 54 ]$$

Then, we introduce the discriminant D shown by the subsequent equation:

$$D = \frac{{\sum }_{Y ∈ {S}^{′}} P ( {T}_{{A}_{i} = {a}_{i} \vert i = 0 … {m}_{r} + {m}_{e} - 1}^{n} \vert 〈 〈 {A}_{k} \vert k ∈ Y 〉 〉 )}{P ( {T}_{{A}_{i} = {a}_{i} \vert i = 0 … {m}_{r} + {m}_{e} - 1}^{n} \vert 〈 〈 {A}_{j} \vert j ∈ R 〉 〉 )} , \qquad [ Equation 55 ]$$

where S′={Y|YεS_{Z,m}_{ᵣ}, Y≠R}.

The denominator of the discriminant D is the probability that the determination is correct that the event <<Aⱼ|jεR >> has occurred. The numerator of the discriminant D is the probability that the determination is wrong that the event <<Aⱼ|jεR>> has occurred.

Therefore,

$$D = \frac{{\sum }_{Y ∈ {S}^{′}} {B}^{- {\sum }_{k ∈ Y} {a}_{k}}}{{B}^{- {\sum }_{j ∈ R} {a}_{j}}} , \qquad [ Equation 56 ]$$

where the base B denotes q·(1−p)/[p·(1−q)].

The case that Σ_{kε Y} aₖ becomes the largest, where YεS_{z, mr}, is the case that the elements of the set Y are the subscripts of the tags, which are the first tag to the mᵣ-th tag selected from the series of the tags arranged in the descending order of the number of response times. It is most likely that this combination is the answer. So, we consider that the set R is this.

The case that Σ_{kεY} aₖ becomes the second largest is the case that the elements of the set Y are the subscripts of the tags, which are the selected tags described above but including the (mᵣ+1)-th tag instead of the mᵣ-th tag. Let Σ_{B} denote the value of Σ_{kε Yak} in this case. Assuming that K is the difference in the number of response times between the tag having the mᵣ-th number of response times and the tag having (mᵣ+1)th number of response times, then Σ_{jε R} aⱼ=Σ_{B}+K. So,

$${\sum }_{Y ∈ {S}^{′}} {B}^{- {\sum }_{k ∈ Y} {a}_{k}} ≦ {\sum }_{Y ∈ {S}^{′}} {B}^{- {\sum }_{B}} = {(}_{{m}_{r} + {m}_{e}} {C}_{{m}_{r}} - 1 ) \cdot {B}^{- {\sum }_{B}} \\ ∴ D ≦ \frac{( {}_{{m}_{r} + {m}_{e}}^{}{C}{}_{{m}_{r}}^{} - 1 ) \cdot {B}^{- {\sum }_{B}}}{{B}^{- {\sum }_{j ∈ R} {a}_{j}}} = ( {}_{{m}_{r} + {m}_{e}}^{}{C}{}_{{m}_{r}}^{} - 1 ) \cdot {B}^{K} \qquad [ Equation 57 ]$$

The determination that the event <<Aⱼ|jεR>> has occurred is acceptable when the posterior probability of the event <<Aⱼ|jεR>> is 1−ε or more. This happens when the value of the discriminant D is smaller than the tolerated wrong difference determination probability ε. The tolerated wrong determination probability ε is a real number more than 0 and less than 1, and is supposed to be sufficiently smaller than 1.

Then we get the subsequent equation showing the condition that the K must satisfy.

$$\begin{matrix}K {\approx }^{>} {log}_{B} \frac{ɛ}{{}_{{m}_{r} + {m}_{e}}^{}{C}{}_{{m}_{r}}^{} - 1} \\ = \frac{log ɛ - log ( {}_{{m}_{r} + {m}_{e}}^{}{C}{}_{{m}_{r}}^{} - 1 )}{log \frac{q}{1 - q} - log \frac{p}{1 - p}}\end{matrix} \qquad [ Equation 58 ]$$

The times difference threshold calculating unit 163, by using the CPU 911, calculates the smallest integer K that satisfy the subsequent equation, as the times difference threshold.

$$K > \frac{log ( {}_{{m}_{r} + {m}_{e}}^{}{C}{}_{{m}_{r}}^{} - 1 ) - log ɛ}{log \frac{p}{1 - p} - log \frac{q}{1 - q}} \qquad [ Equation 59 ]$$

For example, suppose that mᵣ=1. Since ₘₑ₊₁C₁=mₑ+1,

$$K > \frac{log {m}_{e} = log ɛ}{log \frac{p}{1 - p} - log \frac{q}{1 - q}} . \qquad [ Equation 60 ]$$

This is the same equation as the second embodiment.

Also, suppose that mₑ=1. Since ₘᵣ₊₁Cₘᵣ=mᵣ+1,

$$K > \frac{log {m}_{r} - log ɛ}{log \frac{p}{1 - p} - log \frac{q}{1 - q}} . \qquad [ Equation 61 ]$$

A flow of the times difference threshold calculating process S630 in the present embodiment is the same as that in the second embodiment. So, the difference is described below, with reference to FIG. 6.

In the modifying logarithm calculating step S636, the times difference threshold calculating unit 163, by using the CPU 911, based on the number of correct tags mᵣ which is defined in advance and the number of wrongly responded tags selected in the wrong response tag number selecting step S635, calculates the number of combinations ₘᵣ₊ₘₑCₘᵣ for selecting the mᵣ number from the (mᵣ+mₑ) number. The times difference threshold calculating unit 163, by using the CPU 911, calculates ₘᵣ₊ₘₑCₘᵣ−1, the difference obtained by subtracting 1 from the calculated number of combinations. The times difference threshold calculating unit 163, by using the CPU 911, calculates log(ₘᵣ₊ₘₑCₘᵣ−1), the logarithm of the calculated difference.

Further, it may be configured that: using the nested loop, the times difference threshold calculating unit 163, by using the CPU 911, calculates the times difference thresholds corresponding to pairs of mᵣ and mₑ, while changing the number of correct tags mᵣ also; and the times difference threshold storing unit 131 stores them, by using the flash memory 920.

FIG. 9 illustrates an example of the times difference threshold calculated by the times difference threshold calculating unit 163 of the present embodiment.

The vertical axis indicates the number of wrongly responded tags. The horizontal axis indicates the times difference threshold. The dark bars show the quotients calculated by the times difference threshold calculating unit 163 in the real number times difference threshold calculating step S641. And the shaded bars show the times difference threshold calculated by the times difference threshold calculating unit 163 in the integer times difference threshold calculating step S642.

In this example, the times difference threshold is calculated based on the assumption as follows: the response probability of the correct tag p is 0.8, the response probability of the wrong tag q is 0.2, the tolerated error ε is one millionth, and the number of correct tags mᵣ is 2.

FIG. 10 is an example of the times difference threshold calculated by the times difference threshold calculating unit 163 of the present embodiment.

In this example, the times difference threshold is calculated based on the same assumption as the case of FIG. 9 but that the number of correct tags mᵣ is 3.

The comparison of FIG. 8 (the case when mᵣ=1), FIG. 9 and FIG. 10 shows that increasing the number of correct tags mr causes a need to increase the times difference threshold in order to determine all of the correct tags as correct.

Further, it may be configured that: the upper limit of the number of wrongly responded tags is defined in advance as similar as described in the second embodiment; the times difference threshold calculating unit 163, by using the CPU 911, calculates the times difference threshold corresponding to the upper limit of the number of wrongly responded tags defined in advance; and the apparatus determining unit 132, by using the CPU 911, determines the correct tags by using the times difference threshold corresponding to the upper limit of the number of wrongly responded tags, regardless of the actual number of wrongly responded tags.

In the determining apparatus (the RFID reader apparatus 100) of the present embodiment, the times difference threshold calculating unit 163, by using the processing apparatus (the CPU 911), works out an integer that satisfy the subsequent equation, as the times difference threshold.

$$K > \frac{log ( {}_{{m}_{r} + {m}_{e}}^{}{C}{}_{{m}_{r}}^{} - 1 ) - log ɛ}{log \frac{p}{1 - p} - log \frac{q}{1 - q}} , \qquad [ Equation 62 ]$$

where K denotes the times difference threshold calculated by the times difference threshold calculating unit 163, ε denotes the probability of the tolerated wrong determination (the tolerated wrong determination probability), p denotes the correct reception probability stored by the correct reception probability storing unit 142, q denotes the wrong reception probability stored by the wrong reception probability storing unit 152, mₑ denotes the number of communication apparatuses not serving as the communication partner (the wrong tags), among the communication apparatuses that transmitted the signals received by the signal receiving unit 121, and mᵣ denotes the number of communication apparatuses serving as the communication partner (the correct tag), among the communication apparatuses that transmitted the signals received by the signal receiving unit 121.

According to the determining apparatus of the present embodiment (the RFID reader apparatus 100), the probability that the apparatus determining unit 132 makes the wrong determination is ensured to be less than or equal to the tolerance probability ε.

The RFID reader apparatus 100 described above determines the correct tag when there are a plurality of correct tags.

When there are M number of correct IDs and one wrong ID, the ID storing table (the reception storing unit 124) uses (M+1) lines for storing a total of M+1 number of IDs. The ID storing table is supposed to store IDs by rearranging the IDs in the descending order of the number of response times. The determination of the correct ID is made by obtaining the difference between the number of ID reading times of the M-th line and the number of ID reading times of the (M+1)-th line, and comparing it with the times difference threshold K.

Let D^{M}₁ denotes the discriminant of the case when the number of correct IDs is M, the number of wrong IDs is 1, so the total number of IDs is M+1. The condition for completing the algorithm is D^{M}₁<ε.

Herein, a₀ denotes the number of reading times of the ID having the largest number (ID₀), a₁ denotes the number of reading times of the ID having the second-largest number (ID₁), a_{M} denotes the number of reading times of the ID having the smallest number (ID_{M}). That is, a₀≧a₁≧a₂≧ . . . ≧a_{M}.

The M number of IDs out of them are supposed to be the correct IDs, and any one of them is supposed to be the wrong ID. In this case, the number of conceivable events is M+1. The events and the probabilities of them are as below.

(1) ID_{M} is the wrong ID, and the others are the correct IDs:

P₀=ProbR(a₀,N,p) . . . . ProbR(a_{M-2},N,p)·ProbR(a_{M-1},N,p)·ProbE(a_{M},N,q) [Equation 63]

(2) ID_{M-1} is the wrong ID, and the others are the correct IDs:

P₁=ProbR(a₀,N,p) . . . ProbR(a_{E-2},N,p)·ProbE(a_{M-1},N,q)·ProbR(a_{M},N,p) [Equation 64]

(i+1) ID_{M-i} is the wrong ID, and the others are the correct ID:

$${P}_{i} = ProbR ( {a}_{0} , N , p ) \cdot … \cdot ProbR ( {a}_{M - i - 1} , N , p ) \cdot ProbE ( {a}_{M - i} , N , q ) \cdot ProbR ( {a}_{M - i + 1} , N , p ) \cdot … \cdot ProbR ( {a}_{M} , N , p ) \\ … \qquad [ Equation 65 ]$$

(M+1) ID₀ is the wrong ID, and the others are the correct IDs:

P_{M}=ProbE(a₀,N,q)·ProbR(a₁,N,p)·ProbR(a₂,N,p) . . . ProbR(a_{M},N,p) [Equation 66]

Among these events, the one having the highest occurrence probability is the event (1) where the ID_{M} having the smallest number of reading times is the wrong ID. The algorithm can finish when the occurrence probability of this event is greater than or equal to 1−ε.

Herein, we introduce the discriminant D^{M}₁ as follows:

$${D}_{1}^{M} = \frac{{P}_{1} + {P}_{2} + … + {P}_{M}}{{P}_{0}} = \frac{1 - {\hat{P}}_{0}}{{\hat{P}}_{0}} = \frac{1}{{\hat{P}}_{0}} - 1. \qquad [ Equation 67 ]$$

Since a_{M}≦a_{M-1}≦a_{M-2} . . . ≦a₁, P₁≧P₂≧ . . . ≧P_{M}. Therefore,

$${D}_{1}^{M} ≦ \frac{M \cdot {P}_{1}}{{P}_{0}} = M \cdot {[ \frac{q ( 1 - p )}{p ( 1 - q )} ]}^{{a}_{M - 1} - {a}_{M}} . \qquad [ Equation 68 ]$$

This shows the discrimination between the wrong ID and the correct ID is determined by K=(a_{M-1}−a_{M}), the deference between the numbers of times the M-th-ranking ID is read and that of the lowest ranking ID, and M, the number of tags having the correct ID, without depending on the number of trial times N.

Therefore, the parameters of the discriminant D^{M}₁ are not a_{M-1} and a_{M} but K. The degree of reliability can be calculated based only on the average rate p of reading the correct ID and the average rate q of reading the wrong ID, which are determined based on the prior communication environment. Hence, the condition for completing the algorithm is:

$${D}_{1}^{M} ≦ M \cdot {[ \frac{q ( 1 - p )}{p ( 1 - q )} ]}^{K} < ɛ . \qquad [ Equation 69 ]$$

This criterion is stricter than the real probability of wrong determination. Therefore, if this value is smaller than the error precision ε required to the system, then a sufficiently correct determination is said to be made.

When solving this for K, we get:

$$K > \frac{log M - log ɛ}{log \frac{p}{1 - p} - log \frac{q}{1 - q}} . \qquad [ Equation 70 ]$$

### Fourth Embodiment

Fourth embodiment will be described.

The identical reference numerals are used for the portions that are common to the RFID reader apparatus 100 described in the first to third embodiments, and their explanations are omitted herewith.

In the first to third embodiments, the correct tag is supposed to respond at least once or more, for a trial of n times.

The present embodiment is configured with consideration for the possibility that the correct tag do not respond even once to a trial of n times.

For example, suppose that two tags A₀ and A₁ have responded for a trial of n times, and the number of response times of the tag A₀ is a₀ times, and the number of response times of the tag A₁ is a₁ times. Assuming that the number of correct tags is 1, we consider the case when the tag A₂ which has not responded even once is the correct tag.

Considering the case when the tag A₂ is the correct tag, the determination can be made by regarding the case as that the three tags A₀, A₁ and A₂ have responded for a trial of n times (where the number of response times of the tag A₂ is 0). Here, when the tag A₂ is the correct tag, then the tag A₀ and the tag A₁ are the wrongly responded tags. So, the number of wrongly responded tags is 2. Therefore, in the configuration described in the third embodiment, for example, the determination made by using the times difference threshold in the case when the number of correct tags mᵣ is 1 and the number of wrongly responded tags mₑ is 2, ensure that the probability of making the wrong determination is less than or equal to the tolerated wrong determination probability ε.

The flow of the apparatus determining step S620 of the present embodiment is similar to the second embodiment. So the difference will be described below, with reference to FIG. 7.

In the wrong response tag number acquiring step S621, the apparatus determining unit 132, by using the CPU 911, based on the number of reception times stored by the reception storing unit 124, counts the number of tags that have responded even once to the identification requesting command transmitted by the request transmitting unit 112 in the previous trial, as the number of wrongly responded tags.

The point of difference with the second embodiment is the treatment of the number of responded tags as it is as the number of wrongly responded tags, instead of subtracting the number of the correct tags from the number of responded tags.

In this way, the determination of the correct tag is made by even taking into account a rare case of the correct tag not responding even once for a trial of n times, thereby ensuring with more certainty the probability of making the wrong determination is less than or equal to the tolerated wrong determination probability ε.

The RFID reader apparatus 100 as described above ensure a prescribed reliability even by taking into consideration the possibility that the correct ID has not been read and the IDs read are all wrong IDs.

Suppose that two IDs A and B are read, and their numbers of reading times are a and b respectively, for an ID readout trial of N times. There are 3 combinations of the correct/wrong IDs, and their probabilities are:

(1) the case when A is the correct ID, B is the wrong ID

P₀=ProbR(a,N,p)·ProbE(b,N,q) [Equation 71]

(2) the case when A is the wrong ID, B is the correct ID

P₁=ProbR(b,N,p)·ProbE(a,N,q) [Equation 72]

(3) the case when A is the wrong ID, B is also the wrong ID

P₂=ProbE(a,N,q)·ProbE(b,N,q)·ProbR(0,N,p) [Equation 73]

Here, ProbR(0, N, p), the last term of P₂, indicates the probability that the correct ID existing other than A and B has not been read for N consecutive times.

Here, we define α as α=P₂/P₁. Then,

$$\begin{matrix}α = \frac{{P}_{2}}{{P}_{1}} \\ = \frac{ProbE ( b , N , q ) \cdot ProbR ( 0 , N , p )}{ProbR ( b , N , p )} \\ = {[ \frac{q ( 1 - p )}{p ( 1 - q )} ]}^{b} {( 1 - q )}^{N} .\end{matrix} \qquad [ Equation 74 ]$$

Since 0<q<p<1, 0<α<1.

We introduce the discriminant D′¹₁ as follows:

$${{D}^{′}}_{1}^{1} = \frac{{P}_{1} + {P}_{2}}{{P}_{0}} = \frac{1 - {\hat{P}}_{0}}{{\hat{P}}_{0}} = \frac{1}{{\hat{P}}_{0}} - 1 \\ \begin{matrix}{{D}^{′}}_{1}^{1} = ( 1 + α ) \frac{{P}_{1}}{{P}_{0}} \\ = {( 1 + α ) [ \frac{q ( 1 - p )}{p ( 1 - q )} ]}^{K} < {2 [ \frac{q ( 1 - p )}{p ( 1 - q )} ]}^{K} ,\end{matrix} \qquad [ Equation 75 ]$$

where K=a−b.

Solving this for K, we get:

$$K > \frac{log 2 - log ɛ}{log \frac{p}{1 - p} - log \frac{q}{1 - q}} . \qquad [ Equation 76 ]$$

This is the same result as the case when the number of wrong IDs is 2.

For example, when ε is 10 to the power of minus 6, [log(2)−log(ε)]/log(ε)=1.05. Therefore, K takes a value that is approximately 5% larger. This value does not alter the processing time to a great extent.

### Fifth Embodiment

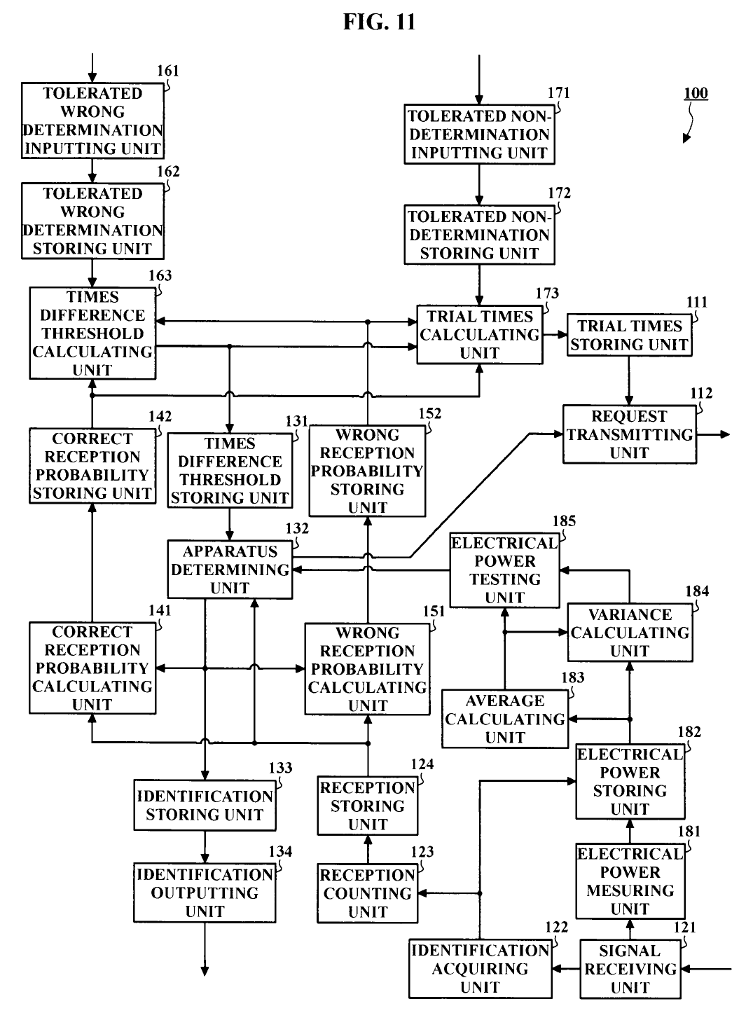

Fifth embodiment will be described with reference to FIGS. 11 to 13.

The identical reference numerals are used for the portions that are common to the RFID reader apparatus 100 described in the first and second embodiments, and their explanations are omitted herewith.

In the present embodiment, the configuration will be described for determining the correct tag based on an electrical power of the signal transmitted by the tag when the correct tag could not have been determined from the number of response times.

FIG. 11 illustrates a block configuration chart showing an example of the functional block configuration of the RFID reader apparatus 100, in accordance with the present embodiment.

The RFID reader apparatus 100, in addition to the configuration described in the first embodiment, further includes an electrical power measuring unit 181, an electrical power storing unit 182, an average calculating unit 183, a variance calculating unit 184, and an electrical power testing unit 185.

The electrical power measuring unit 181, by using the CPU 911, measures the received power (RSSI: received signal strength indicator) of the signal received by the signal receiving unit 121. The electrical power measuring unit 181, by using the CPU 911, outputs data indicating the received power measured.

The electrical power storing unit 182, by using the CPU 911, inputs the data outputted by the electrical power measuring unit 181 and the identification data outputted by the identification acquiring unit 122. The electrical power storing unit 182, by using the RAM 914, stores a pair of the inputted identification data and the data indicating the received power.

The average calculating unit 183, by using the CPU 911, inputs the data stored by the electrical power storing unit 182. The average calculating unit 183, by using the CPU 911, based on the inputted data, calculates an average value of the received power classified for each tag that transmitted the signal received by the signal receiving unit 121. The average calculating unit 183, by using the CPU 911, outputs the data indicating the calculated average value.

The variance calculating unit 184, by using the CPU 911, inputs the data stored by the electrical power storing unit 182 and the data outputted by the average calculating unit 183. The variance calculating unit 184, by using the CPU 911, based on the inputted data, calculates an unbiased variance of the received power classified for each tag that transmitted the signal received by the signal receiving unit 121. The variance calculating unit 184, by using the CPU 911, outputs the data indicating the calculated unbiased variance.

The electrical power testing unit 185, by using the CPU 911, inputs the data outputted by the average calculating unit 183 and the data outputted by the variance calculating unit 184. The electrical power testing unit 185, by using the CPU 911, based on the inputted data, tests whether or not there is a significant difference between the average values of the received power classified for each tag. The electrical power testing unit 185, by using the CPU 911, outputs data indicating the tested result.

For example, the Welch's t test may be used for testing. That is, the electrical power testing unit 185, by using the CPU 911, calculates the test statistic t₀ and the degree of freedom ν, using the subsequent equations.

$${t}_{0} = \frac{\vert {\overline{P}}_{1} - {\overline{P}}_{2} \vert}{\sqrt{\frac{{U}_{1}}{{n}_{1}} + \frac{{U}_{2}}{{n}_{2}}}} \\ and \\ v = \frac{{( \frac{{U}_{1}}{{n}_{1}} + \frac{{U}_{2}}{{n}_{2}} )}^{2}}{\frac{{U}_{1}^{2}}{{n}_{1}^{2} ( {n}_{1} - 1 )} + \frac{{U}_{2}^{2}}{{n}_{2}^{2} ( {n}_{2} - 1 )}} , \qquad [ Equation 77 ]$$

where barred P₁ and barred P₂ denote the average values of the received power for each tag; U₁ and U₂ denote the unbiased variances of the received power for each tag; n₁ and n₂ denote the numbers of reception times for each tag.

The electrical power testing unit 185, by using the CPU 911, based on the test statistic t₀ and the degree of freedom ν calculated, calculates the probability (the upper probability) where the threshold is the test statistic t₀ in the t-distribution of the degree of freedom ν. That is, the electrical power testing unit 185 calculates the probability that the statistic t is greater than the test statistic t₀, as a significant probability Pₑ. For example, the electrical power testing unit 185, by using the flash memory 920, stores a t-distribution table in advance, and by using the CPU 911, searches the stored t-distribution table to acquire the upper probability when the degree of freedom ν and the test statistic to are close to the calculated values, and calculates the significant probability Pₑ by using the linear interpolation or others.

The electrical power testing unit 185, by using the CPU 911, compares the calculated significant probability Pₑ with the tolerated wrong determination probability ε stored by the tolerated wrong determination storing unit 162.

When the significant probability Pₑ is smaller than the tolerated wrong determination probability ε, the null hypothesis “average values of the received signal strengths for each tag are all equal” is rejected. So, the electrical power testing unit 185, by using the CPU 911, determines that there is a significant difference between the average values of the received power for each tag.

The apparatus determining unit 132, by using the CPU 911, inputs the data outputted by the electrical power testing unit 185. The apparatus determining unit 132, by using the CPU 911, based on the inputted data, determines the tag, the received power of which is larger, as the correct tag when there is a significant difference in the average values of the received power classified for each tag. The apparatus determining unit 132, by using the CPU 911, outputs the identification data of the tag determined as the correct tag.

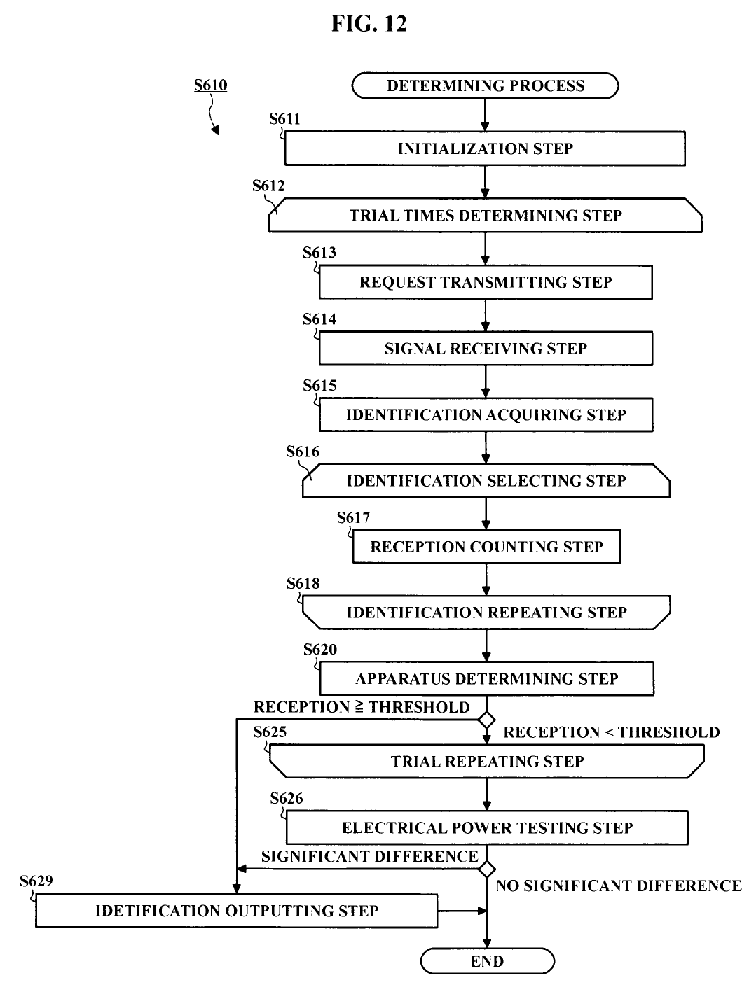

FIG. 12 illustrates a flowchart showing an example of the flow of the determining process S610, in accordance with the present embodiment.

The determining process S610, in addition to the steps described in the first embodiment, further includes an electrical power testing step S626.

When the request transmitting unit 112 determines that the number of trial times has attained the maximum number of trial times in the trial times determining step S612, the RFID reader apparatus 100, by using the CPU 911, proceeds to the electrical power testing step S626.

In the electrical power testing step S626, the electrical power testing unit 185, by using the CPU 911, tests whether or not there is a significant difference between the average values of the received power classified for each tag.

As a result of the test, when the electrical power testing unit 185 has determined that there is a significant difference, then the RFID reader apparatus 100, by using the CPU 911, proceeds to the identification outputting step S629.

As a result of the test, when the electrical power testing unit 185 has determined that there is no significant difference, then the RFID reader apparatus 100, by using the CPU 911, ends the determining process S610 without determining the correct tag.

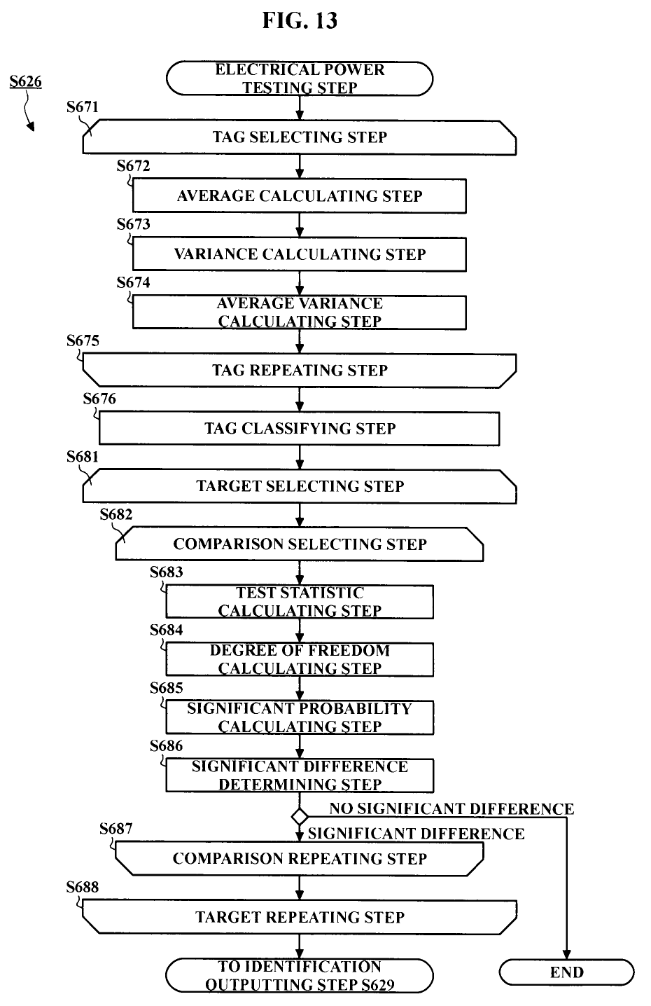

FIG. 13 illustrates a flowchart showing an example of the flow of the electrical power testing step S626, in accordance with the present embodiment.

The electrical power testing step S626 includes a tag selecting step S671, an average calculating step S672, a variance calculating step S673, an average variance calculating step S674, a tag repeating step S675, a tag classifying step S676, a target selecting step S681, a comparison selecting step S682, a test statistic calculating step S683, a degree of freedom calculating step S684, a significant probability calculating step S685, a significant difference determining step S686, a comparison repeating step S687, and a target repeating step S688.

In the tag selecting step S671, the average calculating unit 183, by using the CPU 911, selects a tag one by one successively among the tags, the received power of which the electrical power storing unit 182 stores.

In the average calculating step S672, the average calculating unit 183, by using the CPU 911, calculates a number of the received power P (that is, the number of reception times n) stored by the electrical power storing unit 182, for the tag selected in the tag selecting step S671. The average calculating unit 183, by using the CPU 911, calculates a total sum ΣP of the received power stored by the electrical power storing unit 182, for the tag selected in the tag selecting step S671. The average calculating unit 183, by using the CPU 911, calculates a quotient ΣP/n obtained by dividing the calculated total sum ΣP of the received power by the calculated number of reception times n, to get an average value P⁻ of the received power, for the tag selected in the tag selecting step S671.

In the variance calculating step S673, the variance calculating unit 184, by using the CPU 911, calculates the difference ΔP between the received power P each stored by the electrical power storing unit 182 and the average value P⁻ calculated by the average calculating unit 183 in the average calculating step S672, for the tag selected by the average calculating unit 183 in the tag selecting step S671. The variance calculating unit 184, by using the CPU 911, calculates the square (Δp)² of each of the calculated differences (ΔP) The variance calculating unit 184, by using the CPU 911, calculates the total sum Σ(ΔP)² of the calculated squares (ΔP)². The variance calculating unit 184, by using the CPU 911, calculates a difference (n−1) that subtracts 1 from the number of reception times n calculated by the average calculating unit 183 in the average calculating step S672. The variance calculating unit 184, by using the CPU 911, calculates a quotient Σ(ΔP)²/(n−1) obtained by dividing the total sum Σ(ΔP)² of squares by the calculated difference (n−1), as an unbiased variance U of the received power of the tag selected by the average calculating unit 183 in the tag selecting step S671.

In the average variance calculating step S674, the electrical power testing unit 185, by using the CPU 911, calculates a quotient U/n obtained by dividing the unbiased variance U calculated by the variance calculating unit 184 in the variance calculating step S673 by the number of reception times n calculated by the average calculating unit 183 in the average calculating step S672, as an average variance. The electrical power testing unit 185, by using the CPU 911, calculates (U²/n²), the square of the calculated average variance. The electrical power testing unit 185, by using the CPU 911, calculates a quotient (U²/[n²·(n−1)]) obtained by dividing the square of the calculated average variance by the difference (n−1) calculated by the variance calculating unit 184 in the variance calculating step S673.

In the tag repeating step S675, the average calculating unit 183, by using the CPU 911, determines whether or not all tags, the received power of which the electrical power storing unit 182 stores, have been selected in the tag selecting step S671.

When determining that there is a tag which has not been selected yet, the average calculating unit 183, by using the CPU 911, returns to the tag selecting step S671, and selects the next tag.

When determining that all tags have been selected, the average calculating unit 183, by using the CPU 911, proceeds to the tag classifying step S676.

In the tag classifying step S676, the electrical power testing unit 185, by using the CPU 911, based on the average values P⁻ of the received power for each tag calculated by the average calculating unit 183 in the average calculating step S672, classifies the tags into two groups of a target group and a comparison group. Those tags classified into the target group are determined as the correct tag when there are significant differences in the average value of the received power between them and all the tags classified into the comparison group. The electrical power testing unit 185, by using the CPU 911, in the descending order of the average values P⁻ of the received power for each tag, selects the same number of tags as the number of the correct tags, and classifies them into the target group. The electrical power testing unit 185, by using the CPU 911, classifies the remaining tags into the comparison group. For example, when the number of the correct tags is 1, the electrical power testing unit 185, by using the CPU 911, classifies the tag having the largest average value P⁻ of the received power into the target group, and the other tags are classified into the comparison group.

In the target selecting step S681, the electrical power testing unit 185, by using the CPU 911, selects a tag one by one successively, out of the tags classified into the target group in the tag classifying step S676.

In the comparison selecting step S682, the electrical power testing unit 185, by using the CPU 911, selects a tag one by one successively, out of the tags classified into the comparison group in the tag selecting step S676.

In the test statistic calculating step S683, the electrical power testing unit 185, by using the CPU 911, calculates a difference (P⁻₁−P⁻₂) between the average value P⁻₁ of the received power calculated by the average calculating unit 183 in the average calculating step S672 for the tag selected by the target selecting step S681 and the average value P⁻₂ of the received power calculated by the average calculating unit 183 in the average calculating step S672 for the tag selected in the comparison selecting step S682. The electrical power testing unit 185, by using the CPU 911, calculates the sum (U₁/n₁+U₂/n₂) of the average variance U₁/n₁ calculated in the average variance calculating step S674 for the tag selected in the target selecting step S681 and the average variance U₂/n₂ calculated in the average variance calculating step S674 for the tag selected in the comparison selecting step S682. The electrical power testing unit 185, by using the CPU 911, calculates √(U₁/n₁+U₂/n₂), the square root of the calculated sum of the average variances. The electrical power testing unit 185, by using the CPU 911, calculates a quotient obtained by dividing the calculated difference of average values of the received power by the calculated square root of the sum of the average variances √(U₁/n₁+U₂/n₂), as a test statistic t₀.

In the degree of freedom calculating step S684, the electrical power testing unit 185, by using the CPU 911, calculates the square of the calculated sum of the average variances (U₁/n₁+U₂/n₂) in the test statistic calculating step S683. The electrical power testing unit 185, by using the CPU 911, calculates a sum of the quotient (U₁²/[n₁²·(n₁−1)]) calculated in the average variance calculating step S674 for the tag selected in the target selecting step S681 and the quotient (U₂²/[n₂²·(n₂−1)]) calculated in the average variance calculating step S674 for the tag selected in the comparison selecting step S682. The electrical power testing unit 185 calculates a quotient obtained by dividing the square (U₁/n₁+U₂/n₂)² of the sum of the calculated average variances by the calculated sum, as the degree of freedom ν.

In the significant probability calculating step S685, the electrical power testing unit 185, by using the CPU 911, based on the test statistic t₀ calculated in the test statistic calculating step S683 and the degree of freedom ν calculated in the degree of freedom calculating step S684, calculates the upper probability of the test statistic t₀ in the t-distribution of the degree of freedom ν, as the significant probability Pₑ.

In the significant difference determining step S686, the electrical power testing unit 185, by using the CPU 911, compares the significant probability Pₑ calculated in the significant probability calculating step S685 with the tolerated wrong determination probability ε stored by the tolerated wrong determination storing unit 162.

When the significant probability Pₑ is smaller than the tolerated wrong determination probability ε, then the electrical power testing unit 185, by using the CPU 911, determines that there is a significant difference, and proceeds to the comparison repeating step S687.

When the significant probability Pₑ is greater than the tolerated wrong determination probability ε, then the electrical power testing unit 185, by using the CPU 911, determines that there is no significant difference, and ends the electrical power testing step S626.

In the comparison repeating step S687, the electrical power testing unit 185, by using the CPU 911, determines whether or not all the tags classified into the comparison group in the tag classifying step S676 has been selected in the comparison selecting step S682.

When determining that there is a tag which has not been selected yet, the electrical power testing unit 185, by using the CPU 911, returns to the comparison selecting step S682, and selects the next tag.

When determining that all the tags classified into the comparison group has been selected, the electrical power testing unit 185, by using the CPU 911, proceeds to the target repeating step S688.

In the target repeating step S688, the electrical power testing unit 185, by using the CPU 911, determines whether or not all the tags classified into the target group in the tag classifying step S676 has been selected in the target selecting step S681.

When determining that there is a tag which has not been selected yet, the electrical power testing unit 185, by using the CPU 911, returns to the target selecting step S681, and selects the next tag.

When determining that all the tags classified into the target group has been selected, the electrical power testing unit 185, by using the CPU 911, ends the electrical power testing step S626, and proceeds to the identification outputting step S629.

In this way, the electrical power testing unit 185 determines whether or not all combinations of the tags classified into the target group and the tags classified into the comparison group have significant differences in the average value of the received power. When determining that all the combinations have significant differences, the apparatus determining unit 132 determines that the tags classified into the target group by the electrical power testing unit 185 are the correct tags. When determining that any one of the combinations has no significant difference, the apparatus determining unit 132 ends the determining process S610 without determining the correct tag.

Meanwhile, the method for testing whether or not there is a significant difference in the average value of the received power, is not limited to the Welch's t test, and other testing methods may be applied.

The determining apparatus (the RFID reader apparatus 100) of the present embodiment, further includes the electrical power measuring unit 181 and the electrical power testing unit 185.

The electrical power measuring unit 181, by using the processing apparatus (the CPU 911), measures the received power of the signal received by the signal receiving unit 121.

The electrical power testing unit 185, by using the processing apparatus, when the difference in the number of reception times calculated by the apparatus determining unit 132 is less than the times difference threshold, based on the received power measured by the electrical power measuring unit 181, tests whether or not there is a significant difference between an average value of the received power of a certain communication apparatus (a tag) and an average value of the received power of another communication apparatus.

The apparatus determining unit 132, by using the processing apparatus, when the result of testing by the electrical power testing unit 185 is the determination that there is a significant difference between the average values of the received power, it determines the communication apparatus having the larger average value of the received power as the communication partner (the correct tag).

According to the determining apparatus (the RFID reader apparatus 100) of the present embodiment, when the apparatus determining unit 132 cannot determine the communication partner based on the difference in the number of reception times, it determines the communication partner when there is a significant difference in the average value of the received power, thereby reducing the instances of not being able to determine the communication partner.

The determining apparatus (the RFID reader apparatus 100) of the present embodiment further includes the average calculating unit 183 and the variance calculating unit 184.

The average calculating unit 183, by using the processing apparatus (the CPU 911), based on the identification data acquired by the identification acquiring unit 122, calculates the average value P⁻ of the received power measured by the electrical power measuring unit 181 for each one of the communication apparatuses (the tags 821 to 823) identified by the identification data.

The variance calculating unit 184, by using the processing apparatus, based on the identification data acquired by the identification acquiring unit 122, calculates a variance (the unbiased variance U) of the received power measured by the electrical power measuring unit 181 for each one of the communication apparatuses identified by the identification data.

The electrical power testing unit 185, by using the processing apparatus, based on the average value P⁻ of the received power calculated by the average calculating unit 183 and the variance of the received power calculated by the variance calculating unit 184, tests whether or not there is a significant difference between the average values P⁻ of the received power.

The determining apparatus (the RFID reader apparatus 100) of the present embodiment performs a test having a prescribed reliability based on the statistical measures, since the electrical power testing unit 185 tests whether or not there is a significant difference, based on the average values and the variances of the received power calculated for each communication apparatus.

The RFID reader apparatus 100 described above comprises (a) a storing unit (the electrical power storing unit 182) that stores a total sum and a square sum of the received power values of the tag for each ID; (b) a calculating unit (the average calculating unit 183 and the variance calculating unit 184) that calculates an average value and an unbiased variance of the received power of the tag for each ID; and (c) a determining unit (the electrical power testing unit 185) that determines a specific ID as the correct ID, based on the statistical measures, by using the average and the unbiased variance of the received power of the tag for each ID.

According to the RFID reader apparatus 100 described above, it determines the correct ID by the difference in the number of reading times of the tag ID, and when the determination cannot be made from the difference in the number of reading times, it uses the received power (RSSI) at a time of receiving the tag and performs the determination correctly.

The ID storing table (the electrical power storing unit 182) includes rows for storing a total sum of the RSSI and a square sum of the RSSI for each ID (the identification data).

The ID determining unit receives an ID value and an RSSI value that accompanies it. The ID determining unit updates the ID storing table, to update the rows for the total sum of the RSSI and the square sum of the RSSI, in accordance with the RSSI value received.

The ID determining unit calculates the average and the unbiased variance of RSSI for each ID when a number of loop times (the number of trial times) N is equal to the maximum number of loop times (the maximum number of trial times) L. It calculates the significant probability Pₑ from the test, and determines that the Pₑ is less than or equal to ε.

For example, let us assume that the two types of IDs (A and B) have been read. The magnitude of the RSSI value means the clarity of reading the tag at a large received power. That is, the larger the value, the higher the possibility is, that the tag is the correct tag. The smaller the value, the higher the possibility is, that it is the wrong ID.

The ID storing table stores the total sum and the square sum of RSSI value calculated based on the RSSI value each time. For example, the ID storing table stores 16 as the number of reading times, 128 as the RSSI total sum, and 1066 as the RSSI square sum for A, and stores 14 as the number of reading times, 41 as the RSSI total sum, and 16 as the RSSI square sum for B.

The ID determining unit (the average calculating unit 183) calculates a sample average=(the RSSI total sum/the number of reading times). In the above example, the ID determining unit calculates 8.0 as the sample average for A and 2.9 as the sample average for B.

The ID determining unit (the variance calculating unit 184) calculates an unbiased variance=(the RSSI square sum−the RSSI total sum×the sample average)/(the number of reading times−1). In the above example, the ID determining unit calculates 2.8 as the unbiased variance for A, and 3.6 as the unbiased variance for B.

The ID determining unit (the electrical power testing unit 185), calculates the significant probability Pₑ from the test. For example, it performs one-sided test by utilizing the Welch's t test, by taking as the null hypothesis that an average of RSSI for A and an average of RSSI for B are equal, and as the alternative hypothesis that there is a difference between these averages.

The ID determining unit, based on the sample numbers, the sample average, and the unbiased variance for each group, calculates the test statistic t₀ and the degree of freedom ν. In the above example, the ID determining unit calculates t₀=7.7, ν=26.2.

The ID determining unit, based on the test statistic t₀ and the degree of freedom ν, calculates a one-sided occurrence probability of t-distribution, in other words, the significant probability Pₑ. In the above example, the ID determining unit calculates “ten to the power of minus seven” as Pₑ.

The ID determining unit compares the tolerated wrong probability (the tolerated wrong determination probability) ε with the calculated significant probability Pₑ. When Pₑ is smaller, the null hypothesis is rejected, and the alternative hypothesis is employed. That is, the ID determining unit, based on statistical grounds, determines that there is a significant difference between the average of RSSI for A and the average of RSSI for B.

When determining that there is a significant difference between the averages of RSSI, the ID determining unit determines the ID having the larger average of RSSI as the correct ID.

While the present invention has been described with reference to exemplary embodiments, it is to be understood that the invention is not limited to the disclosed embodiments. The scope of the following claims is to be accorded the broadest interpretation so as to encompass all modifications, equivalent structures, and functions.

What is claimed is:

1. A determining apparatus for receiving each signal transmitted by one or more communication apparatuses, and determines a communication apparatus serving as a communication partner out of the communication apparatuses transmitted the signal received, the determining apparatus comprising:
a receiving apparatus for receiving a signal,
a processing apparatus for processing data,
a signal receiving unit,
an identification acquiring unit,
a reception counting unit, and
an apparatus determining unit; and
wherein the signal receiving unit, by using the receiving apparatus, receives each signal transmitted by one or more communication apparatuses, a plurality of times;
wherein the identification acquiring unit, by using the processing apparatus, based on each signal received by the signal receiving unit, acquires identification data for identifying the communication apparatus that has transmitted the signal received by the signal receiving unit;
wherein the reception counting unit, by using the processing apparatus, based on the identification data acquired by the identification acquiring unit, counts each number of reception times the signal receiving unit has received the signal, for each communication apparatus identified by the identification data;
wherein the apparatus determining unit, by using the processing apparatus, based on the number of reception times counted by the reception counting unit, calculates a difference in the number of reception times between one communication apparatus and another communication apparatus, compares the difference in the number of reception times calculated with a prescribed times difference threshold, and determines a communication apparatus having a more number of reception times as the communication partner, when the difference in the number of reception times is greater than or equal to the times difference threshold.

2. The determining apparatus according to claim 1, further comprising a storage apparatus for storing data, a correct reception probability storing unit, a wrong reception probability storing unit, and a times difference threshold calculating unit;
wherein the correct reception probability storing unit, by using the storage apparatus, stores as a correct reception probability, a probability that the signal receiving unit receives a signal transmitted by a communication apparatus serving as a communication partner;
wherein the wrong reception probability storing unit, by using the storage apparatus, stores as a wrong reception probability, a probability that the signal receiving unit receives a signal transmitted by a communication apparatus not serving as a communication partner;
wherein the times difference threshold calculating unit, by using the processing apparatus, calculates the times difference threshold based on the correct reception probability stored by the correct reception probability storing unit and the wrong reception probability stored by the wrong reception probability storing unit; and
wherein the apparatus determining unit, by using the processing apparatus, determines a communication apparatus serving as a communication partner, by treating the times difference threshold calculated by the times difference threshold calculating unit as a prescribed times difference threshold.

3. The determining apparatus according to claim 2, further comprising a correct reception probability calculating unit;
wherein the correct reception probability calculating unit, by using the processing apparatus, calculates the correct reception probability, based on the number of reception times counted by the reception counting unit; and
wherein the correct reception probability storing unit, by using the storage apparatus, stores the correct reception probability calculated by the correct reception probability calculating unit.

4. The determining apparatus according to claim 2, further comprising a wrong reception probability calculating unit;
wherein the wrong reception probability calculating unit, by using the processing apparatus, calculates the wrong reception probability, based on the number of reception times counted by the reception counting unit; and
wherein the wrong reception probability storing unit, by using the storage apparatus, stores the wrong reception probability calculated by the wrong reception probability calculating unit.

5. The determining apparatus according to claim 1, further comprising an electrical power measuring unit, and an electrical power testing unit;
wherein the electrical power measuring unit, by using the processing apparatus, measures a received power of the signal received by the signal receiving unit;
wherein the electrical power testing unit, by using the processing apparatus, tests whether there is a significant difference between an average value of the received power of a communication apparatus and an average value of the received power of another communication apparatus, based on the received power measured by the electrical power measuring unit, when the difference in the number of reception times calculated by the apparatus determining unit is less than the times difference threshold; and
wherein the apparatus determining unit, by using the processing apparatus, determines a communication apparatus having a larger average value of the received power as the communication partner, when a result of testing by the electrical power testing unit is a determination that there is a significant difference between the average values of the received power.

6. The determining apparatus according to claim 1, further comprising a transmitting apparatus for transmitting a signal and a request transmitting unit;
wherein the request transmitting unit, by using the transmitting apparatus, transmits a signal for indicating a request for transmission of a signal indicating the identification data, to a communication apparatus, a plurality of times; and
wherein the signal receiving unit, by using the receiving apparatus, receives a signal transmitted by the communication apparatus as a response to a signal transmitted by the request transmitting unit.

7. The determining apparatus according to claim 2, wherein the times difference threshold calculating unit, by using the processing apparatus, works out an integer that satisfies an equation selected out of the subsequent equations:
$$\begin{matrix}K > \frac{- log ɛ}{log \frac{p}{1 - p} - log \frac{q}{1 - q}} , & [ Equation 1 ] \\ K > \frac{log {m}_{e} - log ɛ}{log \frac{p}{1 - p} - log \frac{q}{1 - q}} , and & [ Equation 2 ] \\ K > \frac{log ( {}_{{m}_{r} + {m}_{e}}^{}{C}{}_{{m}_{r}}^{} - 1 ) - log ɛ}{log \frac{p}{1 - p} - log \frac{q}{1 - q}} , & [ Equation 3 ]\end{matrix}$$
where K denotes a times difference threshold calculated by the times difference threshold calculating unit, ε denotes a tolerated wrong determination probability, p denotes a correct reception probability stored by the correct reception probability storing unit, q denotes a wrong reception probability stored by the wrong reception probability storing unit, mₑ denotes a number of communication apparatus not serving as the communication partner, out of the communication apparatus that has transmitted the signal received by the signal receiving unit, and mᵣ denotes a number of communication apparatus serving as the communication partner, out of the communication apparatus that has transmitted the signal received by the signal receiving unit.

8. The determining apparatus according to claim 3, further comprising a total correct reception calculating unit and a correct reception opportunity calculating unit;
wherein the total correct reception calculating unit, by using the processing apparatus, sums up the number of reception times counted by the reception counting unit for a communication apparatus determined by the apparatus determining unit as the communication partner, as a total number of correct reception times;
wherein the correct reception opportunity calculating unit, by using the processing apparatus, sums up the number of times that the signal receiving unit has had an opportunity to receive a signal for the communication apparatus determined by the apparatus determining unit as the communication partner, as a number of correct reception opportunity times; and
wherein the correct reception probability calculating unit, by using the processing apparatus, calculates a quotient obtained by dividing the total number of correct reception times calculated by the total correct reception calculating unit by the number of correct reception opportunity times calculated by the correct reception opportunity calculating unit, as a correct reception probability.

9. The determining apparatus according to claim 4, further comprising a total wrong reception calculating unit and a wrong reception opportunity calculating unit;
wherein the total wrong reception calculating unit, by using the processing apparatus, sums up the number of reception times counted by the reception counting unit for a communication apparatus determined by the apparatus determining unit as not serving as the communication partner;
wherein the wrong reception opportunity calculating unit, by using the processing apparatus, sums up the number of times that the signal receiving unit had had a opportunity to receive a signal for the communication apparatus determined by the apparatus determining unit as not serving as the communication partner, as a number of wrong reception opportunity times; and
wherein the wrong reception probability calculating unit, by using the processing apparatus, calculates a quotient obtained by dividing the total number of wrong reception times calculated by the total wrong reception calculating unit by the number of wrong reception opportunity times calculated by the wrong reception opportunity calculating unit, as a wrong reception probability.

10. The determining apparatus according to claim 5, further comprising an average calculating unit and a variance calculating unit;
wherein the average calculating unit, by using the processing apparatus, based on the identification data acquired by the identification acquiring unit, calculates each average value of the received power measured by the electrical power measuring unit, for each communication apparatus identified by the identification data;
wherein the variance calculating unit, by using the processing apparatus, based on the identification data acquired by the identification acquiring unit, calculates each variance of the received power measured by the electrical power measuring unit, for each communication apparatus identified by the identification data; and
wherein the electrical power testing unit, by using the processing apparatus, based on the average value of the received power calculated by the average calculating unit and the variance of the received power calculated by the variance calculating unit, tests whether or not there is a significant difference between the average values of the received power.

11. A computer readable medium that stores a computer program for making a computer including a receiving apparatus for receiving a signal and a processing apparatus for processing data, function as the determining apparatus of claim 1.

12. A determining method of the determining apparatus including a receiving apparatus for receiving a signal and processing apparatus for processing data, for receiving each signal transmitted by one or more communication apparatuses, and for determining a communication apparatus serving as a communication partner out of the communication apparatuses that transmitted the signal received, the determining method comprising:
for the receiving apparatus to receive each signal transmitted by one or more communication apparatuses, a plurality of times;
for the processing apparatus to acquire identification data for identifying the communication apparatus that has transmitted the signal received by the receiving apparatus, based on the signal received by the receiving apparatus;
for the processing apparatus to count each number of reception times that the receiving apparatus has received the signal, for each communication apparatus identified by the identification data, based on the acquired identification data; and
for the processing apparatus to compare a difference between a number of reception times of a communication apparatus and a number of reception times of another communication apparatus with a prescribed times difference threshold based on the numbers of reception times counted, and to determine a communication apparatus having a more number of reception times as the communication partner, when the difference in the number of reception times is greater or equal to the times difference threshold.
